(19) United States
(12) Patent Application Publication
(10) Pub. No.: US 2014/0136237 A1
(43) Pub. Date: May 15, 2014

(54) HEALTHCARE DATA MANAGEMENT SYSTEM

(71) Applicants: Nicholas G. Anderson, Knoxville, TN (US); John S. Pollack, Naperville, IL (US); David F. Williams, Minnetonka, MN (US)

(72) Inventors: Nicholas G. Anderson, Knoxville, TN (US); John S. Pollack, Naperville, IL (US); David F. Williams, Minnetonka, MN (US)

(21) Appl. No.: 14/077,714

(22) Filed: Nov. 12, 2013

Related U.S. Application Data
(60) Provisional application No. 61/841,977, filed on Jul. 2, 2013.
(60) Provisional application No. 61/826,677, filed on May 23, 2013.
(60) Provisional application No. 61/781,125, filed on Mar. 14, 2013.
(60) Provisional application No. 61/725,709, filed on Nov. 13, 2012.

(51) Int. Cl. G06F 19/00

(52) U.S. Cl. CPC G06F 19/322
USPC 705/3

(57) ABSTRACT

Efficient computer distribution of healthcare information is achieved by computer aggregating the healthcare information directly from multiple sources, namely, computers of healthcare providers, including EHR vendors, and patients. Financial incentives to share information are provided to the sources. Healthcare information may de-identified by removing some specific information about the patient and the provider, and inserting generalized information about each. Healthcare providers and patients may prohibit use of their information, limit the content of their information, and control to whom their information is sold. Compensation and distribution of information among purchasers may be controlled to ensure fairness. The healthcare information may be analyzed, reordered and filtered to generate data or reports in response to a purchase request.

### CROSS REFERENCE TO RELATED APPLICATIONS

Priority is claimed to the following Provisional Applications: Application No. 61/725,709 filed Nov. 13, 2012; Application No. 61/781,125 filed Mar. 14, 2013; Application No. 61/826,677 filed May 23, 2013; and Application No. 61/841,977 filed Jul. 2, 2013; all of the above referenced provisional applications having inventors: Nicholas G. Anderson, John S. Pollack, and David F. Williams.

### FIELD

The present disclosure relates to the field of healthcare record management. Specifically, the present disclosure is related to a system for promoting the exchange of healthcare data between patients, healthcare providers, and healthcare data purchasers.

### BACKGROUND

Healthcare data is a valuable source of information for a variety of industries including pharmaceutical companies, medical device manufacturers, research institutions, financial industry members, government agencies, and medical practitioners. However, healthcare data sold to these industries is typically obtained indirectly and may not include all relevant information. Further, information collected and sold may not be associated with a particular physician or healthcare provider, thereby making it even more difficult to effectively utilize the medical data.

Healthcare data purchasers such as pharmaceutical companies, healthcare industry members, financial industry members and governmental agencies may obtain healthcare data from a variety of sources including information obtained by pharmacies about a particular patient when they fill a prescription with the pharmacy. The prescription information may not be associated with a particular physician, and purchasers of the information may attempt to correlate the data to a particular physician using publicly available listings of physicians. For example, the American Medical Association (“AMA”) maintains a Physician Masterfile, which includes information related to every physician practicing in the U.S. One recent study has suggested that up to 60% of all physicians included in the Masterfile were unaware that their information was available, and were further unaware that their data was being sold through the Masterfile. Additionally, once physicians were notified of their inclusion in the Masterfile and that their information was being sold, 75% were opposed to their information being sold by the AMA. In the same study, only 10% of physicians were aware that there was an option to “opt-out” of the Masterfile. (Medscape.com, AMA Discloses Masterfile Physician Data to Pharmaceutical Companies, http://www.medscape.com/viewarticle/559704?src=mp.) Further, physicians do not control who may view information in the Masterfile or who may view patient information associated with the particular physician.

Accordingly, it is desirable to provide a system of managing healthcare data allowing greater control of the data by healthcare providers and encouraging the sharing of patient medical data and other healthcare data between patients, healthcare providers, and healthcare data purchasers.

### SUMMARY OF INVENTION

A more complete, accurate, timely and efficient distribution of healthcare information is achieved by aggregating healthcare information directly from the sources, namely, health care providers and patients themselves and by providing incentives directly to the providers or patients. Middle men, like pharmacies or the AMA, have incomplete information that is time delayed. Providers and patients, on the other hand, have extremely timely and complete information. The accuracy of the information is also always best at the source. Incentives applied at the source also encourage participation in distribution of information that might otherwise be withheld. In addition, a direct financial incentive at the source inherently creates more enthusiasm and more resources for the creation of accurate electronic information.

In accordance with one embodiment of the invention, healthcare information is aggregated and distributed to purchasers, and the healthcare providers or the patients or both are compensated. The healthcare information is derived from a plurality of patients and a plurality of healthcare providers and is stored in a computer database implemented on one or more computers. The computer database includes hardware, software and electronic data. Each item of healthcare information is associated with a patient and at least one healthcare provider, and the healthcare information includes identifying information that identifies the associated patients and the associated healthcare providers.

To perform the method, communication is established between the computer database and a purchaser, and de-identified healthcare information is computer generated and aggregated from multiple sources. The de-identified healthcare information includes at least some of the healthcare information but does not include certain identifying information relating to the patient identities or the healthcare provider identities or both.

At least a portion of the de-identified healthcare information is stored in the computer database, and in response to a purchaser request, requested information that is based on at least a portion of the de-identified healthcare information from the computer database is communicated to the purchaser. Based in part upon the requested information or the de-identified information or both, a computer calculates compensation for one or more of the healthcare providers and patients. As used herein, the term “computer” is used in a broad sense referring to a device or devices performing data processing.

The healthcare information may be stored in a plurality of first computer databases implemented on computers with each first computer database including hardware, software and electronic data. Communication is established between the first computer databases and a broker computer database implemented on a computer. The broker computer database also includes hardware, software and electronic data. In addition, communication is established between the broker computer database and a purchaser.

De-identified healthcare information is computer generated by aggregating some of the healthcare information from the plurality of first computer databases. The de-identified healthcare information again includes some of the healthcare information but does not include certain identifying information. At least a portion of the de-identified healthcare information is stored in the broker computer database, and in response to a purchaser request, requested information is communicated to the purchaser. The requested information is based on at least a portion of the de-identified healthcare information from the broker computer database to the purchaser. Usage information is stored in the broker computer database based on the requested information provided to the purchaser, and based on the usage information, a computer calculates compensation for one or more of the healthcare providers and patients. Based on the calculation, healthcare providers or patients or both are compensated.

The burden of storing the de-identified healthcare information may be shared between the plurality of first computer databases and the broker computer database. For example, the broker computer database may store some of the de-identified healthcare information, but when a purchaser makes a request for healthcare information, the broker computer database may respond by collecting the requested information from the first computer databases and then communicating the requested information to the purchaser. Alternatively, the broker computer database may send instructions to one or more first computer databases, and the first computer databases will respond to those instructions by sending the requested information directly to the purchaser. The requested information sent to the purchaser may be raw data or it may be a report based on the healthcare information contained in the first computer databases and the broker computer database.

The incentive to participate in distributing healthcare information may be direct financial incentives to healthcare providers or patients or both. For example, to enable fair compensation, a value may be assigned to individual items of de-identified healthcare information. The values may be based in part upon factors related to the healthcare provider (such as the provider specialty) or the patient (such as the age or disease of the patient). Then, the fee charged to purchasers will be based upon the assigned values of the healthcare information. The compensation calculated for providers or patients or both may also be based on the values assigned to the items of healthcare information.

The compensation collected for providers or patients or both may also be based on fairness criteria which may vary. For example, all of the healthcare providers in a particular group may be compensated equally without regard to any other factor. Alternatively, healthcare providers may be compensated in proportion to the amount of de-identified healthcare that is provided by each healthcare provider. So, a healthcare provider that severely restricts the amount of information that is released to the purchasers will be less compensated than a healthcare provider who imposes few limitations or no limitations on the use or sale of de-identified healthcare information.

To ensure that purchasers do not exert an undue indirect influence on providers, and upper limit called a cap may be placed on the compensation that a healthcare provider may receive. In some instances, the cap may distinguish between industries. For example, purchasers from first and second industries both may purchase the de-identified healthcare information and revenue will be generated from the first and second industries based on those purchases. The compensation for healthcare providers based on revenue from the first industry may be limited to a cap to avoid indirect undue influence or the appearance of impropriety. However, the calculation of compensation based on sales to the second industry may be unlimited (not subject to the cap). A cap is not necessary because the second industry has a remote relationship to healthcare providers.

The de-identified healthcare information may include a unique coded patient identifier that identifies the patient. Since this unique coded identifier is stored in the de-identified healthcare information, analysis is improved. For example, even though the real identity of the patient is not known, using the unique coded patient identifier a healthcare history for a particular unique patient identifier may be assembled from the de-identified healthcare information.

Likewise de-identified healthcare information may include a unique coded provider identifier that identifies a healthcare provider associated with a particular item of de-identified healthcare information. Using the unique coded provider identifier, studies may be performed to determine information about a particular unique healthcare provider without knowing the actual identity of the healthcare provider. So, for example, utilizations and outcomes of a particular healthcare provider may be tracked without knowing the identity of the provider.

In accordance with another feature, the de-identified healthcare information may be tagged to associate de-identified healthcare information with particular patients or particular healthcare providers or both. A healthcare provider may have multiple different tags, all of which identify the same healthcare provider. Based on the tags, the patients and healthcare providers whose de-identified healthcare information was communicated to a purchaser may be identified. Based on the patient identification, or the healthcare provider identification, or both, and the usage information, the patients or their healthcare providers may be compensated for the use of the de-identified healthcare information. Thus, patient tags and healthcare provider tags facilitate the compensation of persons who actually provide healthcare information that is ultimately sold to purchasers in the form of de-identified healthcare information.

A tagging system may also be utilized so that a healthcare provider or a patient can give or withhold permission to use healthcare information in the de-identified healthcare information. For example a single unique tag or a series of different tags may be associated with a particular healthcare provider. If such particular healthcare provider withholds permission to use healthcare information, then healthcare information tagged to the particular healthcare provider is either not included in the de-identified healthcare information or is included in the de-identified healthcare information but is not provided to purchasers based on the tags associated with the particular healthcare provider. Stated another way, based on the tags associated with healthcare providers, a computer is programmed to provide purchasers with only de-identified healthcare information for which permission has been given by the associated healthcare providers.

The tagging method described above may further include associating opt-out tags with patients and/or healthcare providers. Either the broker computer database or the first databases may be programmed not to provide purchasers with de-identified healthcare information corresponding to patients or healthcare providers who are associated with opt-out tags. Alternatively, such programming may exclude selected healthcare information from the de-identified healthcare information based on the opt-out tags.

The tagging method may also provide for selected desired use of the healthcare information. For example, the de-identified healthcare information may be tagged with computer tags that identify the patient associated with each event reported in the healthcare information. For each patient, a designation or tag is provided in a computer indicating no desired groups, one desired group, or more than one desired group who may receive the de-identified healthcare information associated with the particular patient. When a request from a specific purchaser is received, the specific group of the specific purchaser is identified. Based on the computer tags and the desire groups designated for each patient, the specific purchaser is provided only with de-identified healthcare information that is designated for the specific group. Likewise, similar tags may be used in association with healthcare providers such that a particular healthcare provider may designate no groups, one group or more than one group that can receive healthcare information associated with a particular healthcare provider.

In accordance with yet another embodiment each item of de-identified healthcare information is tagged with an EHR tag to identify an EHR server, and based on usage information and the EHR tags, a computer calculates compensation for the EHR vendor whose de-identified healthcare information is communicated to a purchaser. Likewise de-identified healthcare information may be tagged to identify clinical trial data and the computer database may be programmed to prevent access by purchasers who are not authorized to access clinical trial data.

The step of generating de-identified healthcare information may include the creation of information as well as the removal of information. For example, de-identified healthcare information may be generated by first removing predetermined information that may tend to uniquely identify a particular patient. Then, the removed information is replaced with generalized information that is related to the removed predetermined information. For example, the exact age or birthday of the patient may be replaced with a range of ages. The range of ages is generalized information that is less likely to identify a particular patient. In addition, a unique patient identification code or number may be associated with each item of de-identified healthcare information so that the generalized information for a particular patient may be tracked over time without knowing the actual identity of the patient.

The step of generating de-identified healthcare information may also include removing information about a particular healthcare provider and replacing that information with the demographic information that is insufficient to uniquely identify a healthcare provider but is sufficient to provide improved analysis of the de-identified healthcare information. The healthcare provider demographics may include age ranges, geographic areas, the specialty of the healthcare provider, and characteristics of a practice group associated with a healthcare provider, if any.

In accordance with yet another feature, the healthcare information includes standardized interoperability documents containing a plurality of data elements. The step of computer generating de-identified data includes selecting data elements from one or more of the interoperability documents and storing selected elements in the de-identified healthcare information. In addition, the healthcare information may be computer analyzed to recognize specific diagnostic test and to further recognize numerical data in the test. Then, the identity of recognized tests and recognized numerical data is stored in a computer as separate data. Furthermore, the de-identified healthcare information may be filtered to create a subset of de-identified healthcare information meeting the filter criteria. A computer then compiles and aggregates the subset into an aggregate report providing information aggregated from a plurality of patients or events.

In yet another feature, de-identified healthcare information is computer analyzed to identify and select one or more of the patients and healthcare providers suitable for answering questions related to a particular subject. A survey is created and pre-populated based on the de-identified healthcare information corresponding to the selected healthcare providers and patients. The pre-populated survey is transmitted to the selected ones of the healthcare providers and patients along with a request to participate in the survey.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is an illustration of a data management system according to one embodiment of the disclosure;

FIG. 2 is a flow chart illustration of the flow of healthcare data according to one embodiment of the disclosure;

FIG. 3 is an illustration of a data management system including one or more filter modules according to one embodiment of the disclosure;

FIG. 4 is a flow chart illustration of searching healthcare data according to one embodiment of the disclosure;

FIG. 5 is an exemplary healthcare provider profile according to one embodiment of the disclosure;

FIG. 6 is a flow chart illustration of a data management system according to one embodiment of the disclosure; and

FIG. 7 is a flow chart illustration of a data management system according to one embodiment of the disclosure.

### DETAILED DESCRIPTION

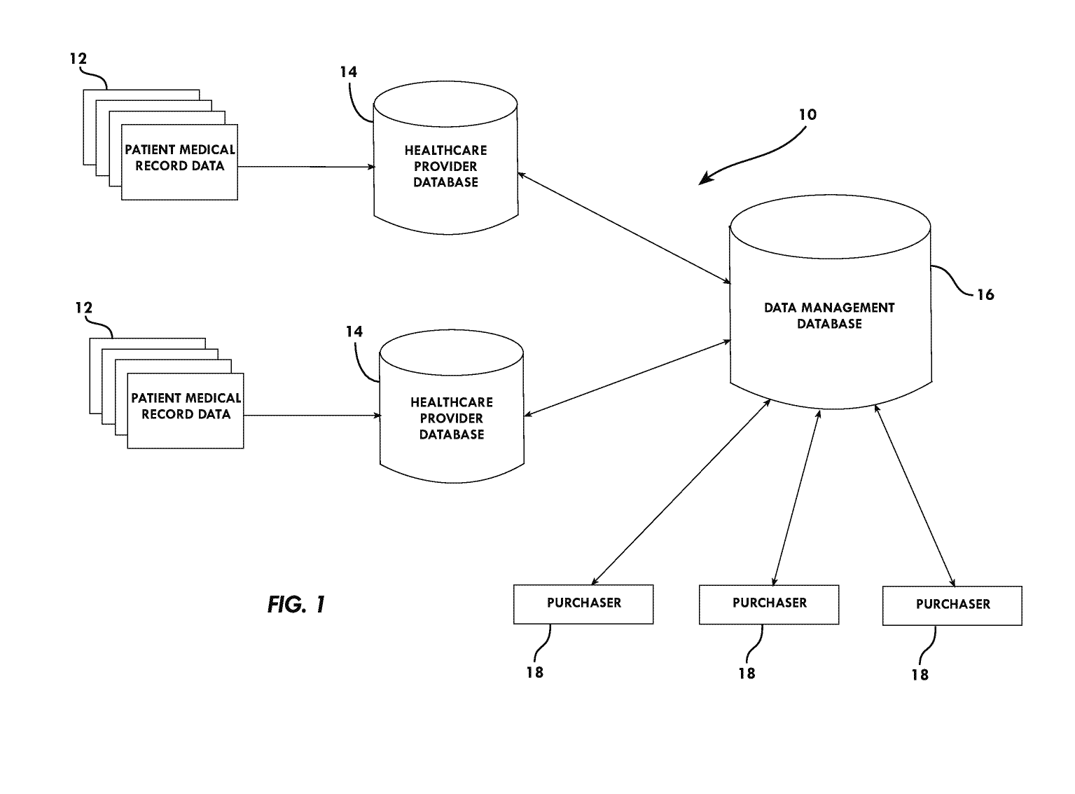

With initial reference to FIG. 1, the present disclosure relates to a system for managing healthcare provider data 10. Healthcare data such as patient medical record data 12 from one or more healthcare provider databases 14 is compiled on a data management database 16 and sold to one or more purchasers 18. The healthcare provider data management system 10 allows patient medical record data 12 corresponding to a particular physician to be de-identified by removing physician-identifiable information (such as physician name or address or other information) and/or patient identifiable information (such as name, date of birth, social security number or other information) and sold to purchasers 18 within certain relevant industry groups, while allowing healthcare providers or patients to be compensated for the healthcare provider's associated patient medical record data. By serving as a broker between purchasers, healthcare providers, and/or patients, the medical practice data management system 10 promotes the flow of complete and accurate medical record data to relevant purchasers while incentivizing healthcare providers and/or patients to provide, or approve the provision of, detailed records and to share those records with purchasers. Healthcare providers may include physicians, psychologists, dentists, chiropractors, optometrists, nurse practitioners, physician assistants, nurses and other allied health professionals and practices or businesses in those fields as well as hospitals, ambulatory surgical centers, laboratories, diagnostic centers, treatment centers, and other related healthcare facilities.

Patient medical record data 12 is generated when a patient visits and is examined, tested, or treated by a physician or other healthcare provider and may be collected from existing paper medical records, electronic medical records, electronic summary documents (e.g. Continuity of Care Documents (“CCD”) or Health Summary), electronic Healthcare Information Exchange (HIE) protocols and databases, pharmaceutical inventory systems, practice management software, billing software, or Accountable Care Organization (ACO) records, databases, and protocols. For example, CCD information may be used. Electronic CCDs are one example of a standardized form of electronic medical records, and include information for an individual patient such as medical problems, procedures, test results, clinical findings, family history, current and past medications, vital signs, and a plan of care. Electronic records such as CCDs allow clinical summary information for patients to be easily shared between health care entities.

In addition to electronic medical records, physical paper records and records from other sources may be manually converted into electronic form for sharing. For example, paper medical records may be scanned into a computer and the text from the paper medical records reviewed using optical character recognition to extract patient information from the paper medical record. Alternatively, information from the paper medical records may be manually entered into a standard electronic record form.

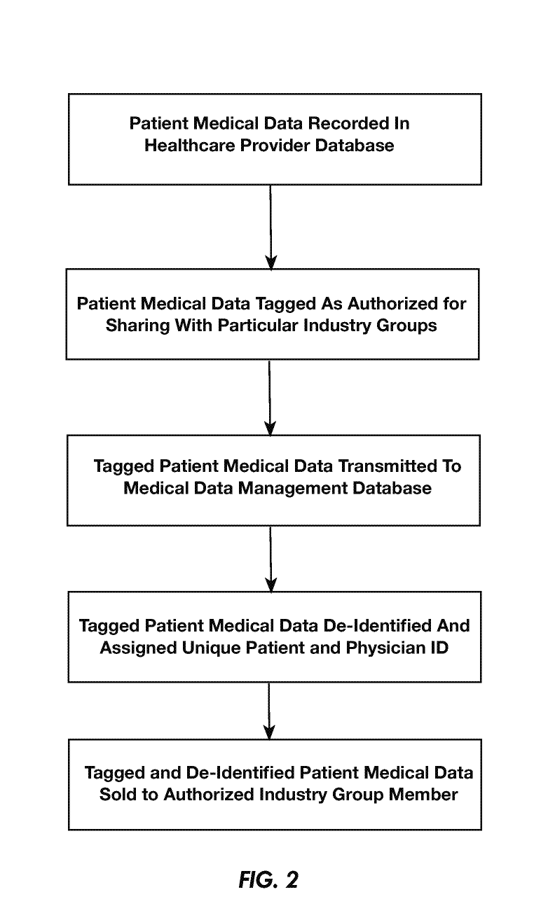

Referring to FIG. 2, in a first step patient medical record data 12 is compiled in one or more healthcare provider databases 14. Typically healthcare providers maintain patient information in either paper or electronic form in the healthcare provider database 14, the patient information including information available in the existing paper medical records, electronic medical records, electronic health record vendor databases, electronic summary documents (e.g. Continuity of Care Documents (“CCD”) or Health Summary), electronic HIE protocols and databases, pharmaceutical inventory systems, practice management software, billing software, or ACO medical records and databases. Patient medical record data is either recorded manually in a patient's file or recorded electronically during a visitation, such with a portable tablet or other electronic device. Additional records of treatments for a particular patient may also be obtained from other healthcare providers and stored in the healthcare provider database 14.

Exemplary databases comprise at least one processor and memory, the memory comprising one or more of random access memory (RAM) and a main storage medium including one or more hard drives. The memory may be included within the database or, alternatively, may be located remotely from the system such as a cloud storage system. The database may communicate with one or more networks such as a local area network (LAN), a wireless network, and the internet, and may thereby communicate with other databases through the one or more networks. As used herein the term “database” or “computer database refers to both hardware, software and electronic data unless indicated otherwise by context.

In addition to clinical information, the patient medical record data also includes information identifying the particular patient and information that identifies the healthcare provider providing services to that patient. Patient medical record data may also include multiple record entries for a particular patient corresponding to multiple treatments or visits with a particular physician or physicians and other healthcare providers.

The multiple patient treatments or visits with the healthcare provider may be recorded in the medical record data to show the date of each treatment or visit. Alternatively, each patient treatment or visit may be designated as an interval in the data management database rather than a designated specific date. For example, current HIPAA laws do not allow de-identified patient medical record data to include dates of service more specific than a particular calendar year in which the patient sought treatment from a healthcare provider. Therefore, the data management database may record patient treatments or visits on an interval basis. An interval basis is defined in the data management database by the first treatment or encounter with a healthcare provider and the relative time to subsequent treatments or visits.

For example, when the data management database receives patient medical record data, the data management database determines whether a medical record corresponding to that patient has previously been received by the data management database. If a medical record has been received, then the interval time between the date of the new medical record and the date of the previous or initial medical record for that patient is calculated and reported as the number of days since the treatment of the first medical record corresponding to that patient. If a patient had a first medical record entered into the data management database with a date of June 1, and a second medical record is entered with a date of July 1, then an interval time is given of 31 days. If a patient does not yet have a corresponding medical record in the data management database, then the date of the first medical record is listed as day 0 and subsequent medical records have an interval time based on the first medical record.

When the patient medical record data is compiled in the healthcare provider database 14, the medical record data may be further tagged by the corresponding physician(s) or healthcare provider(s) depending on which industry groups or specific purchasing entities the healthcare provider desires to share the patient medical record data with. For example, a healthcare provider may desire to share patient medical record data corresponding to that particular healthcare provider with members of research and finance industry groups, but not pharmaceutical groups. The healthcare provider tags each individual patient's medical record with the desired industry groups to share the data with. A healthcare provider may designate that all healthcare data corresponding to the healthcare provider be shared with a set of desired industry groups or specific purchasing entities.

A healthcare provider may designate that none of the healthcare data corresponding to the healthcare provider be shared with any industry groups or specific purchasing entities. A healthcare provider may also designate that the healthcare data corresponding to the healthcare provider may be shared with specific industry groups or specific purchasing entities with or without the healthcare provider's identity associated with his or her shared healthcare data. Means of identification would include, for example, provider name, provider Social Security number, provider identification numbers such as Unique Physician Identification Number (UPIN) or National Provider Identifier (NPI) or Drug Enforcement Agency (DEA) number or AMA Physician Masterfile Number, healthcare payer provider identification number, or other means of identification. For example, a healthcare provider may authorize healthcare data corresponding to the healthcare provider be provided to a customer in the financial industry with his or her associated identification, but provide healthcare data corresponding to the healthcare provider to a customer in the pharmaceutical industry only without his or her associated identification.

The patient may also designate the relevant industry groups or other recipients allowed access to their personal medical record data. A patient may designate that none of the healthcare data corresponding to their personal medical record data be shared with any industry groups or specific purchasing entities. A patient may also designate that the healthcare data corresponding to their personal medical record data be shared with specific industry groups or specific purchasing entities with or without the patient's identity associated with his or her shared healthcare data. Alternatively, the patient medical record data may be tagged as corresponding to a particular healthcare provider or patient or usage authorization or identification authorization after the medical record data is transmitted to the data management database. The data management database may tag the patient medical record to a particular healthcare provider(s) or patient or usage authorization or identification authorization after receiving the medical record data from the healthcare provider database or patient or other source of healthcare records based on information provided by the healthcare provider or patient. For example, the physician or patient authorizations may be obtained from the physician or patient, stored in the database, and tagged or associated with corresponding physician or patient healthcare records after they are received from the healthcare provider database or other source of healthcare records.

When a physician, healthcare provider, or patient elects to participate in the medical record data management system 10, patient medical record data 12 from the healthcare provider database or patient is transmitted to the data management database 16. Patient medical record data 12 is received in electronic form and stored in one or more computer storage mediums comprising the data management database 16. Patient medical record data 12 from various healthcare provider databases is collected in the data management database.

The patient medical record data 12 from the healthcare provider database 14 is periodically sent to the data management database. When the data management database receives the periodic patient medical record data, the patient medical record data is scanned to determine new entries, and the new entries are added to the data management database. When a new medical record is created or a prior record is updated, the new information is automatically “pushed” to the data management database, thereby providing the data management database with up-to-date records for patients within the healthcare provider system. In a system wherein new information is pushed, new and updated patient medical record data is actively transferred from the healthcare provider database or other healthcare record source to the data management database. The data management database may alternatively automatically send a request to the healthcare provider database and fetch updated medical records from the healthcare provider database.

Alternatively, the data management database is in communication with the healthcare provider database and a party requesting medical record data such that when a request is made for a particular medical record, the data management database transmits the medical record data to the requesting party. By requesting the data from the healthcare provider database and transmitting the data directly to the requesting party, the data management database is not required to store the medical record data, but instead transmits the information between the healthcare provider and the requesting party.

Electronic health care records such as CCD documents that contain all of the information obtained during a given patient encounter may be automatically electronically transmitted to the data management system. For example, when a medical record is desired by the data management system, a request may be automatically sent to the relevant healthcare provider database(s) requesting all health records corresponding to that particular patient. Alternatively, the healthcare provider database(s) or other healthcare record source in communication with the data management system automatically send electronic health records such as CCD documents to the data management system whenever a patient visits a healthcare provider and new information is generated in the patient's electronic health records.

CCD records are preferably obtained by the data management database because CCDs provide a template that is readily used by multiple electronic health record systems that includes all the demographic, clinical, laboratory, and diagnostic data for a patient visit. The CCD is interoperable between different electronic health record systems and allows healthcare providers to share patient information with one another, regardless of where the patient was seen, whether it was a primary care physician, a specialist office, emergency room, hospital, or other location. Because CCDs have a common architecture and are generated by substantially all electronic health record systems, the information contained in CCDs is easily pulled by the data management database. Further, access to CCD information is not blocked by electronic health record vendors, therefore access to CCDs should remain readily available. While the retrieval of data from CCDs is discussed herein, it is also understood that the data management database is capable of retrieving data from other standardized or interoperable healthcare-related documents or forms.

The data management database may pull all CCDs for all patients of a given healthcare provider over a given period of time or at designated periodic intervals. Selected CCDs may be obtained by the data management database based on the date of service, a particular diagnosis code, procedure code, or other identifying information. The CCDs may be collected either locally at a healthcare provider and transmitted to the data management database or may be requested directly from a healthcare provider by the data management database. When the CCDs are collected locally at a healthcare provider, CCDs are obtained by the healthcare provider from an electronic health record server or healthcare provider server to submit to the data management database. CCDs may be obtained and de-identified locally at the healthcare provider before transmitting to the data management database to thereby increase the privacy of information contained in the data management database.

The data management database may automatically obtain and aggregate CCDs based on either the provider or based on the patient. For example, all CCDs on every patient that a particular provider or hospital encounters may be automatically obtained. Alternatively, CCDs from every healthcare provider that a particular patient sees may be automatically obtained. Multiple CCDs for a particular patient are collected by the data management database and married according to the process described below.

In addition to electronic healthcare records such as CCDs, other healthcare data such as from healthcare provider drug inventory tracking and usage systems, healthcare provider drug inventory data, healthcare provider drug usage data, healthcare provider medical device inventory tracking and usage systems, healthcare provider medical device inventory data, healthcare provider medical device usage data, healthcare provider management software, healthcare provider billing software, utilization reports, pharmaceutical electronic prescribing systems, and other relevant data may be stored in the data management database either alone or in connection with other medical record data received by the data management database.

The patient medical record data received or transmitted by the data management database is de-identified such that any indicia indicating the identity of the particular patient is removed. For example, when the data management database receives an electronic medical record document, the data management database may automatically collect data based on information included in the electronic medical record such as patient medical history, treatment, treating healthcare providers, and other relevant information. The data management database pulls the relevant information and compiles the patient data in a de-identified medical record data.

The data management database analyzes each individual patient medical record to determine whether the record is complete. If a patient medical record is found to be incomplete, the medical record may be flagged by the data management database designating that the record is incomplete. Flagged records may be segregated for manual review. Incomplete medical records may be withheld from being transmitted to purchasers. Alternatively, incomplete medical records may be analyzed and any useful medical data contained in the medical record may be extracted from the medical record and transmitted to purchasers according to the process described below. Providers may not be paid for incomplete records.

Further, the data management database may analyze each patient medical record based on an expected number of completed fields and compare the fields that are completed in the patient medical record with fields required by the data management database. A number of required fields may be entered into the data management database for patient medical records received by the data management database. When the data management database receives the patient medical record, the patient medical record is analyzed to verify that the required fields as designated in the data management database have been completed in the patient medical record. For example, fields such as the patient's name, geographic location, and blood pressure may be designated as required fields, while other fields such as the patient's temperature at the time of visiting the healthcare provider may be designated as non-essential and therefore not required. If the patient medical record does not contain the required completed fields, then the patient medical record may either be purged by the data management database or segregated from other received patient medical records for further review. If the patient medical record contains missing fields which are defined as non-essential or required, the record may be integrated into the data management database without further review. The required fields may be entered into the data management database by a user based on the information desired by the user, and only medical records desired by the user are analyzed based on the required fields. Alternatively, a minimum number of required fields may be entered for the data management database for all received medical records.

In addition to analyzing each field in the patient medical record, the data management database may further analyze each individual field for locating and storing specific data points from a particular data field. For example, one data field in a patient medical record may include diagnostic test interpretations by a healthcare provider. The diagnostic test interpretation may include both text and specific numerical measurements taken during diagnostic testing. The diagnostic test interpretation may be analyzed by the data management database to recognize any numerical measurements and to subsequently store the numerical measurements as separate elements.

For example, a physician may interpret an Optical Coherence Tomography scan and the interpretation may be included in a patient medical record. The interpretation may include primarily text but may also include numerical information such as a Central Macular Thickness measurement. When the patient medical record is received by the data management database, the interpretation is analyzed and the Central Macular Thickness data is located and stored in the patient medical record as a separate data point.

Additionally, one or more keywords from patient medical record data fields such as diagnostic test interpretations may be recognized by the data management database and stored as separate data elements. A reference table may be stored in the data management database containing keywords to search for within a patient medical record. When the data management database receives a patient medical record, the data fields may be analyzed and any keywords matching the reference table may be pulled from the patient medical record and stored as a separate data entry. Examples of key words may include an exam or test finding such as “blood” and “infiltrate” or a descriptor such as “active,” “inactive,” “attached,” and “resolved.”

While FIG. 2 illustrates de-identifying the medical record data after being transmitted to the data management database, it is also understood that patient medical record data may be de-identified locally at each of one or more healthcare provider databases before the medical record data is transmitted to the data management database. By de-identifying patient medical record data locally at the healthcare provider, patient privacy is preserved by preventing identifiable patient medical record data from being stored on the data management database.

In one example, patient medical records are pulled from the healthcare provider by the data management database. The medical record is de-identified when it is received by the data management database but before being stored in the data management database. The medical record may be de-identified in accordance with HIPAA or other relevant standards wherein elements such as the patient's name, date of birth, medical record number, and other identifying information are removed from the medical record. Alternatively, patient medical records are pulled by the data management database from a healthcare provider and stored in the data management database in an identifiable format, the patient medical records being de-identified immediately prior to transmitting or reporting the patient medical record to a purchaser.

Alternatively, identifiable patient medical record data may be pushed or transmitted as described above to a remote server in communication with the one or more healthcare provider databases and the data management database. The healthcare providers may lease storage space on the remote server and transmit identifiable patient medical record data to the remote server to be de-identified. After receiving patient medical record data from the one or more healthcare provider databases, the medical record data is de-identified by the remote server and transmitted to the data management database. The remote server enables the patient medical record data to be de-identified at a central location instead of on each individual healthcare provider database, and further preserves patient privacy by preventing identifiable patient medical record data from being stored on the data management database. The remote server may be owned by either the healthcare provider or by an owner of the data management database individually, co-owned by both or owned by either the healthcare provider or data management database owner and leased to the other party such that identifiable patient data is maintained on a server controlled by an entity with rights to hold such identifiable data.

In yet another alternative, a local network-accessible storage device such as a hard-drive is provided to the healthcare provider. The healthcare provider transmits patient medical data from its healthcare provider database to the local storage device. The patient medical data is de-identified by the local storage device. The local network-accessible storage device is in communication with the data management database and transmits the patient medical data to the data management database after the patient medical data has been de-identified. In this alternative, the healthcare provider owns the local storage device such that no third party is required to transmit the de-identified patient medical data to the data management database.

The data management database may also obtain patient medical record data from one or more Health Information Exchanges (HIEs). HIEs are entities created to assist healthcare providers such as hospitals, physicians, and labs, in sharing medical information. Healthcare providers push or transmit information they desire to share from their databases and electronic health records to a centralized HIE database where other healthcare providers may pull the shared information into their database or electronic health records. By obtaining medical record data from HIEs, the data management database is able to pull medical record data provided by multiple healthcare providers from a single source. Additionally, some HIEs create a communication standard among participating healthcare providers allowing the healthcare providers to easily transmit medical record data to one another. Therefore, the data management database may further be capable of pulling medical record data from HIE communication standards.

The medical record data management system may also work in connection with a third party electronic health record (“EHR”) vendor. Healthcare practices employ EHR vendors to store patient medical record data on an EHR vendor server that is controlled by the EHR vendor. The EHR vendor server may be remote from the healthcare practice and may be configured such that all patient clinical findings and notes, diagnostic tests and results and images, patient clinical and demographic information, outside results and documents and notes, and EHR documents such as CCDs are transmitted from the healthcare practice to the EHR vendor and stored on the EHR vendor server. EHR vendors therefore may already have access to all patient medical record data for a particular healthcare practice. Further, EHR vendors may have agreements in place with one or more medical practices wherein the EHR vendor is authorized to sell patient medical record data from the EHR vendor server.

In addition to EHR vendors, other databases of various vendors may be in communication with the data management database such as practice management software vendors, physician office drug inventory systems vendors, health insurance companies, drug distributor companies, and pharmacies. Data from the above and other related databases may be aggregated by the healthcare data management system and sold to purchasers.

The healthcare data management system may be in communication with the EHR vendor server for tagging and aggregating the patient medical record data on the EHR vendor server. Specifically, the healthcare data management system may be implemented on the EHR vendor server such that patient medical record data stored on the EHR vendor server may be tagged, de-identified and aggregated in accordance with the present disclosure.

In one embodiment, the data management database may be implemented on existing third party EHR vendor databases when the EHR vendors sell medical record data to their existing EHR vendor customers. Patient medical record data stored on third party EHR vendor databases may be tagged according to the method described above to assist EHR vendors in selling their data to their customers.

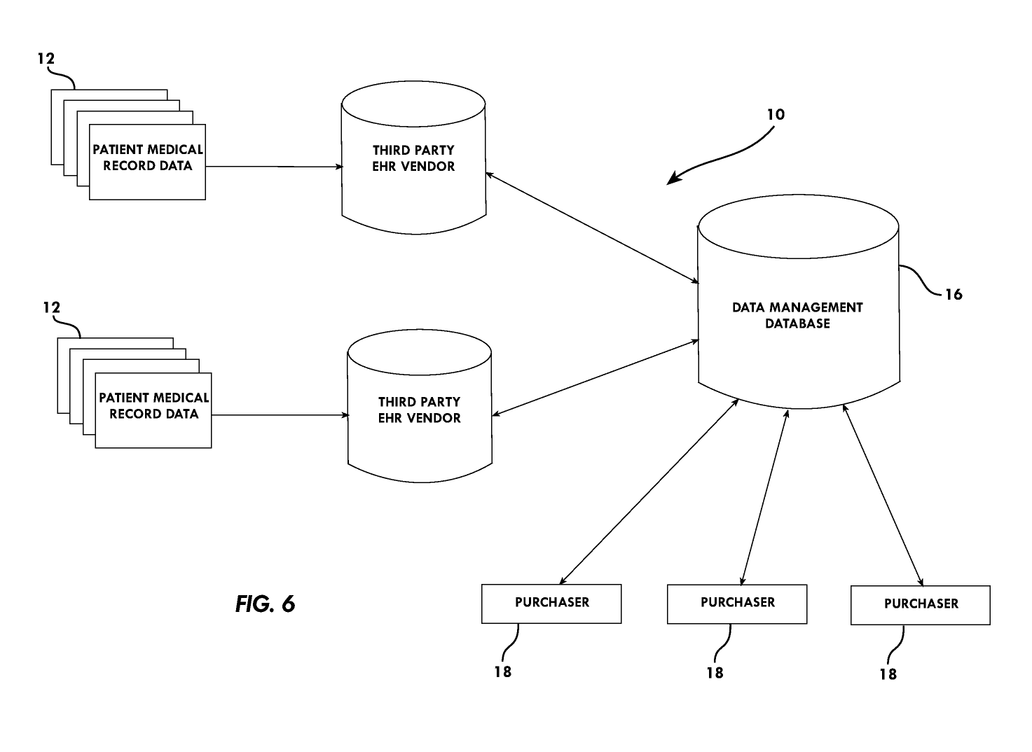

In an alternative embodiment, the one or more EHR vendors transfer patient medical record data stored in an EHR database to the data management database as shown in FIG. 6. The EHR vendor transmits all patient medical record data contained on the EHR database to the data management database. The patient medical record data received from the EHR database may be reviewed against a reference table containing a list of authorized healthcare providers to determine which patient medical record data may then be utilized and stored by the data management database. Data from physicians not included in the reference table of authorized healthcare providers may be deleted or segregated from the data of physicians in the reference table of authorized healthcare providers.

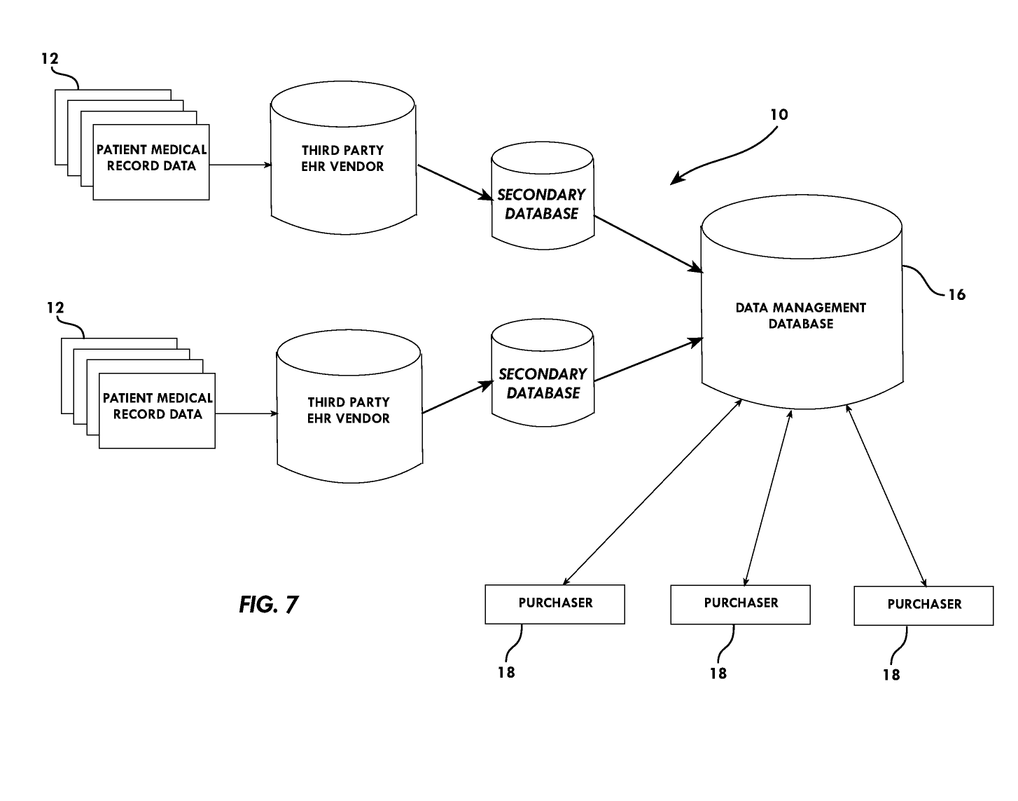

A secondary database may be used by the EHR vendor wherein patient medical record data from healthcare providers that have authorized their patient medical record data to be utilized by the data management database is transferred to the secondary database as shown in FIG. 7. The authorized patient medical record data is then transferred from the secondary database to the data management database to be utilized or sold to one or more purchasers.

The third party EHR vendor periodically updates patient medical record data transmitted to the data management database. In one example, the EHR vendor's entire EHR database of patient medical record data is transmitted on a regular periodic basis. Alternatively, the EHR vendor initially transmits its entire database of patient medical record data or secondary database to the data management database and then periodically transmits updated patient medical record data as new patient encounters with healthcare providers are added to the EHR vendor's records. The data management database may aggregate patient medical record data from multiple EHR databases and secondary databases.

Further, the data management database may aggregate patient medical record data from multiple third party EHR vendors in communication with the data management database and sell the aggregated patient medical record data to purchasers. By aggregating patient medical record data from multiple EHR vendors, a greater volume of patient medical record data and healthcare provider encounter data is available. Further, if a single patient has medical record data from multiple healthcare providers, with the patient medical record data scattered across multiple EHR vendors, the patient's medical record data may be tracked across the multiple EHR vendors in communication with the data management database. EHR vendors would also be encouraged to work together to provide complete patient medical record data.

Patient medical record data may be further tagged with EHR vendor/EHR source information. When patient medical record data tagged according to its EHR vendor or source information and sold to one or more purchasers through the data management database, the one or more EHR vendors may be compensated according to the amount of patient medical record data sold corresponding to that particular EHR vendor. The one or more EHR vendors may be compensated based on the particular EHR vendor's relative contribution of patient medical record data. For example, if a first EHR vendor contributes patient medical record data corresponding to 5,000 patient encounters with healthcare providers and a second EHR vendor contributes patient medical record data corresponding to 10,000 patient encounters with healthcare providers, then the first EHR vendor may receive ⅓^{rd} of revenue attributed to the sale of the patient medical record data while the second EHR vendor may receive ⅔^{rd} of revenue attributed to the sale of the patient medical record data. Alternatively, the one or more EHR vendors may be compensated based on the particular EHR vendor's relative contribution of medical record data based on the relative number of physicians in the data management database using that EHR. For example, if a first EHR vendor contributes healthcare data corresponding to encounters from 500 physicians and a second EHR vendor contributes healthcare data corresponding to encounters from 1000 physicians, then the first EHR vendor may receive ⅓rd of revenue attributed to the sale of patient medical record data while the second EHR vendor may receive ⅔^{rd} of revenue attributed to the sale of patient medical record data.

Alternatively, patient medical record data corresponding to specific encounters with healthcare providers may be tracked and EHR vendors may be compensated based on the sale of specific encounters tagged with the particular EHR vendor information. To track specific encounters corresponding to a particular EHR vendor, the data management database may count the number of patient encounters that come from each EHR vendor. The data management database may also count the percentage of total aggregated patient encounters corresponding to each EHR vendor and each EHR vendor may be compensated based on the percentage of patient encounters attributable to the particular EHR vendor.

The de-identified medical record is linked to a unique alphanumeric code designating the particular patient corresponding to the medical record. The data management database maintains a secure list of the alphanumeric codes and their corresponding patients. If future medical record data are received by the data management database corresponding to the same patient, these records are also de-identified and tagged with the same alphanumeric code such that a particular alphanumeric code corresponds to all entries relating to a particular patient. The patient medical record data is de-identified and assigned a unique code by the individual healthcare providers before transmitting the data to the data management system or is de-identified and assigned a unique code after being transmitted to the data management database.

The unique alphanumeric code linked to an individual patient allows patient medical data to be assigned to the individual patient without revealing the identity of the particular patient. Further, the unique alphanumeric code maintained by the data management database allows patient medical record data to continue to be associated with that patient, even if additional patient medical record data is obtained from multiple physicians or healthcare providers based on different visits or medical procedures.

De-identified patient medical record data is compiled from various sources such that data from multiple platforms for a particular patient is married. For example, medical record data such as electronic health records for a particular patient from multiple visits may be pulled or transmitted to the data management database, de-identified and assigned a unique identification number. Financial data related to the particular patient from the healthcare provider's practice management or billing software is also pulled or transmitted, de-identified, and assigned the unique identification number associated with that particular patient. Additional data related to the particular healthcare provider may be similarly transmitted to the data management database, de-identified and assigned the unique identification number. The data management database thereby marries the various data records from the multiple sources under the unique identification number such that all medical record data for a particular patient are available under the unique identification number. While the process of de-identifying patient medical record data before marrying the data is described above, it is also understood that the patient medical record data may be married before de-identifying the patient medical record data.

A de-identification algorithm may be used to create a unique patient identification number based on a combination of specific patient identifiers such as date of birth, social security number, geographic identifiers, account number, and phone number. The algorithm is applied such that the same unique patient identification number is created for a specific patient regardless of where or when the patient encounter occurs. The algorithm may use a technique such as a one-way hash to prevent re-identification of the patient from the unique patient identification number.

Other information regarding a patient may also be collected by the data management system such as the patient's insurance carrier, zip code, whether the patient resides in an urban or suburban or rural location, and other relevant patient information. This additional patient information, some of which is not typically available in patient medical records, may be pulled from publicly available databases, other data sources such as practice management or patient billing software or payer databases, or may be voluntarily provided by the patient. The additional patient information may be combined with the patient medical data and reported to data purchasers.

In addition to pulling and compiling information on patients from patient medical data, information on each healthcare provider is also pulled and compiled by the data management system. A reference file is created including demographic information of each healthcare provider, the reference file including the healthcare provider's name, physical address, email address, phone number, AMA Masterfile number, Medicare National Provider Identifier (NPI) number, and other relevant healthcare provider information. Other self-reported information is collected by the data management system from the healthcare provider including the healthcare provider's specialty, degree, practice size, whether the provider is an academic or private practice, practice type, and whether the practice is urban or suburban. The aforementioned list of information is not meant to be exhaustive but rather exemplary of informative types of information that may be collected. The information collected by the data management system may either be collected from various other databases such as state medical boards, professional societies or the AMA Masterfile, or may be self-reported by the healthcare provider to the data management system. For example, a healthcare provider may complete a questionnaire when the healthcare provider begins participating in the medical record data management system, or alternatively may compile healthcare provider demographic information from the healthcare provider's web page or other publicly available information.

Additional healthcare provider demographic information may be compiled by the data management system including, but not limited to: healthcare provider age (given in years or as a range), healthcare provider practice size, geographic information, and healthcare provider practice structure. Healthcare provider practice structure information may include whether the practice is a physician owned private practice, or whether the practice is a university or academic practice, HMO, PPO, and ACO information, and whether the practice is a multispecialty practice or single specialty practice.

In one embodiment, geographic information may be pulled and compiled from patient medical records into the data management database to create geographic descriptors for patient encounters with healthcare providers. Data pulled from patient medical records may include the healthcare provider's office location, zip code, or other geographically identifying data. Healthcare providers may provide a list of the healthcare provider's office locations to the data management database, each location being assigned a location classification such as urban, suburban, or rural. A reference table is then created for the data management database including the location classification. When patient medical data is analyzed by the data management database, the patient medical data may be assigned the location classification based on the particular healthcare provider encounter. In one embodiment, a location classification database may be utilized wherein the location is based on zip code, wherein the database may be an existing geographic database.

The information on healthcare providers is affiliated with patient medical data from that healthcare provider such that when a purchaser purchases patient medical data or reports containing patient medical data, the purchaser is also able to view information regarding that patient's healthcare provider that is not typically available in a patient medical record.

The reference file may include additional information about the healthcare provider for patient medical record data as may be required. For example, when a healthcare provider tags their patient medical record data as authorized for use for research purposes, the data may also be tagged as having been authorized by a physician's Institutional Review Board (IRB) for research purposes. When patient medical record data is used for research purposes, in some cases IRB approval may be required.

While the data management database associates healthcare provider information with patient medical record data, the data management database also maintains healthcare provider information in a separate reference file such that the healthcare provider information may be sold to one or more purchasers separate from patient medical record data.

### Healthcare Provider Profile

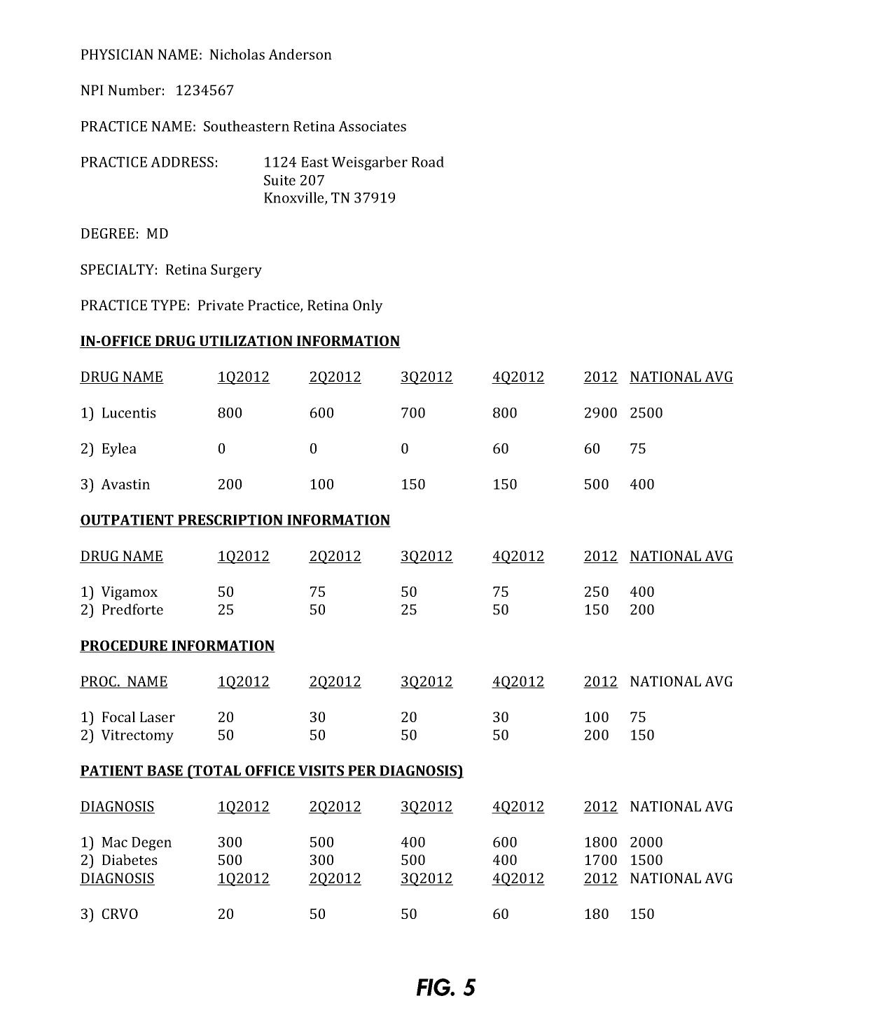

One or more healthcare provider profiles may be created and stored on the data management database. FIG. 5 shows a healthcare provider profile containing information regarding a particular healthcare provider such as drug utilization, procedure utilization, the number of patients seen with various diagnoses, and other relevant information regarding the healthcare provider. The healthcare provider profiles may compile information obtained by the data management database from patient medical data, publically available information, information from the healthcare provider reference file described above, and information submitted by the healthcare provider.

Data displayed in the healthcare provider profile regarding drug utilization, procedure utilization, and diagnoses evaluated by the healthcare provider are generated from patient medical data. General information regarding the healthcare provider's practice is displayed such as the total number of units utilized by the particular healthcare provider, the number of particular procedures performed, and the types of diagnoses made by the healthcare provider. However, information displayed in the healthcare provider profile may not include any identifiable patient information.

The one or more healthcare provider profiles may be accessed by the purchasers if the purchaser is a type of purchaser authorized to view the healthcare provider profile by the healthcare provider. The healthcare provider may designate which types of purchasers are authorized to access their profile, giving the healthcare provider control over how information within their profile is used. For example, the healthcare provider may designate that pharmaceutical companies and medical device manufacturers may access the healthcare provider's profile, while insurance and finance companies are not allowed to access the healthcare provider's profile.

One or more purchasers may purchase the information within the healthcare provider's profile, with the healthcare provider being compensated for providing the information within their profile. The healthcare provider may be compensated at a flat rate or may be compensated based on the number of times their profile is purchased by a purchaser. Further, the amount of compensation a healthcare provider receives for their profile may be based on the number of industries authorized to purchase their profile.

### Searching the Data Management System

When a purchaser desires to purchase patient medical record data corresponding to a particular healthcare provider, drug, treatment, disease, or other information available in the data management database, the purchaser creates a request to open an account for access to the database. In creating an account, the purchaser provides information such as the relevant area of the healthcare industry the purchaser is a member of, as well as the desired use for the medical record data obtained through the data management database by the purchaser.

When a purchaser submits a request for access to the data management database, the purchaser is assigned one or more authorizations for the data management database authorizing the purchaser access to patient medical record data tied to one or more physicians and healthcare providers depending on the authorizations included in the patient medical record data from the physicians or healthcare providers. For example, if a purchaser is a pharmaceutical company wanting to obtain data related to a particular physician's use of a particular drug for marketing purposes, the purchaser is authorized to access all patient medical record data in the data management database that has been designated as authorized for use for marketing purposes. The purchaser provides the purpose for using the medical record data once and is granted access to files on an ongoing based on that initial authorization. Alternatively, the purchaser must submit a request each time the purchaser desires to obtain patient medical record data stating the intended use of the medical record data, and is thereby authorized to use medical record data for each individual use. The platform also provides the purchaser with the ability to access patient data and other healthcare data from individual or multiple de-identified or identified healthcare providers based on the authorization of those providers associated with the medical records.

After creating an account and receiving one or more authorizations, a purchaser may log into the data management database through a portal such as a remote computer terminal or portable device in communication with the data management database using a username and password. After logging in, the purchaser may search for various medical record data that the purchaser is authorized to view using a variety of search criteria. The purchaser may search for medical record data related to a particular physician. As an example, a pharmaceutical company purchaser may search for all usage by a particular physician of one of the pharmaceutical company's drugs. Other search criteria include, but are not limited to, sorting patient medical record data based on a patient's medical history, medical procedures involving particular medical devices, use of medical devices by particular healthcare providers, patient medical histories, and other relevant medical record data. In one illustrative example, a purchaser can search for aggregated medical record data corresponding to a particular drug, diagnosis, or procedure, and a list of the top 100 healthcare providers utilizing the particular drug or performing a particular procedure are displayed.

While a system utilizing a portal and remote computer terminal are described above, it is also understood that a purchaser may request and obtain medical record data and reports by various other methods, such as contacting the data management system by phone or in person and designating the particular medical record data or report the purchaser would like to receive, or by submitting a written request to the data management system.

One or more results or reports corresponding to the search criteria are displayed to the purchaser showing the number of records located and other various preliminary indications of the content of the results. Teaser information may be displayed including a portion of the medical record data located during the search to illustrate the quality of results located to the purchaser. Teaser information may include the number of relevant results and portions of the de-identified medical record data. The teaser information may also include a report aggregating information from the results located for the particular search. The teaser information displayed allows a purchaser to determine whether it wants to purchase the relevant medical record data obtained during the search.

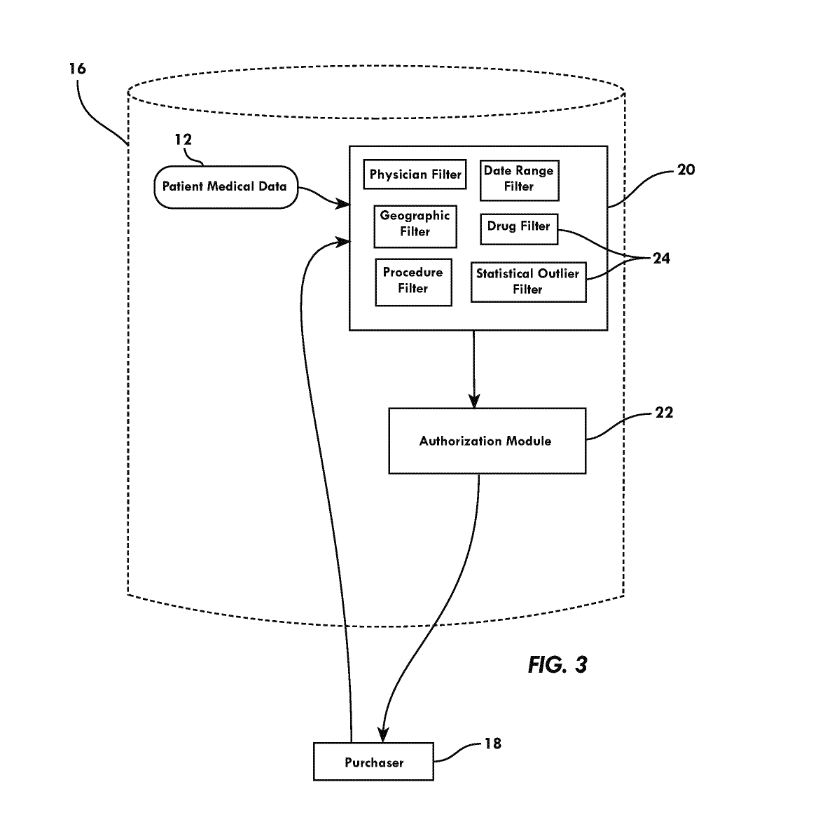

FIG. 3 illustrates a filter module 20 and an authorization module 22 of the data management database 16 for searching and verifying results based on an inquiry by a purchaser 18. The purchaser 18 designates one or more filters 24 and inputs a value for the filter such as, but not limited to, the physician's name, a range of dates, a geographic location, a particular drug or medical device and the procedure performed, as well as a filter to reduce any statistical outliers. Patient medical record data 12 received by the data management database 16 is then run through the various filters. Patient medical record data 12 that satisfies the various filter criteria is then run through the authorization module 22. The authorization module 22 verifies whether the purchaser 18 is allowed to view the particular result based on the purchaser's relevant industry group and intended use of the medical record data 12. If the purchaser is authorized to view the filtered patient medical record data 12, then the data is sent to the purchaser.

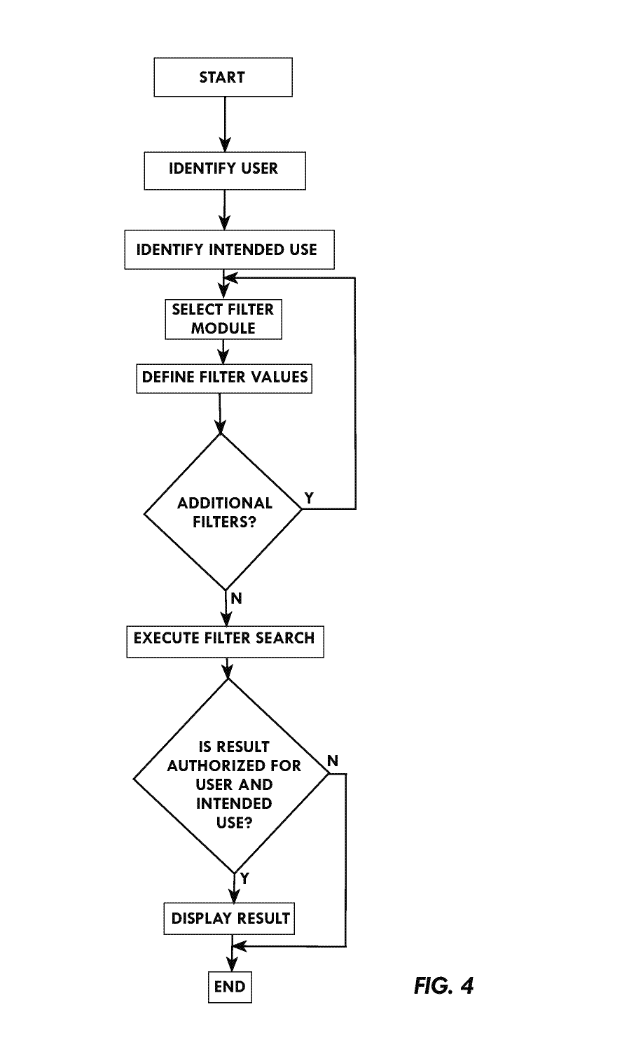

FIG. 4 is a flow chart illustrating the filtration and authorization of medical record data by the data management database 16. In a first step, the data management database 16 identifies the particular user when the user logs on to the database. When the user is identified through an account the user created, the intended uses of the data by the user are also identified. The data management database 16 may further verify the identity of the user and the intended use of the data by the user to confirm that the user is in fact a member of the industry group claimed by the user. The user designates one or more filter modules and filter values and the data management database locates patient medical record data based on the filter criteria. Before displaying the one or more filtered results to the user, the data management database 16 confirms that the user is authorized to obtain the data based on the user's industry group and intended use of the medical record data. If the user is authorized, then the filtered search results are displayed to the user. If the user is not authorized for one or more of the particular results, such as because a particular physician has not approved the user's industry group to view the data, then the result is not displayed to the user.

One or more reports are generated from the results of a particular filtered search using information from the medical record data located in the search. For example, if the user performed a search using a filter module based on an individual patient or healthcare provider, a report may be created aggregating the medical record data related to that particular healthcare provider such as the number of patients seen or the amount of a particular drug or drugs administered by that healthcare provider. If the user performed a search based on aggregated healthcare provider data such as by geographic location, procedure performed, diagnosis, provider specialty, or drug prescribed, data from multiple medical record data sources is aggregated and analyzed to create a report summarizing the medical record data located in the search.

The data management system aggregates patient medical record data and other healthcare data and related corresponding healthcare provider information to present the patient medical record data to a user in a form capable of showing general patient statistics or trends. For example, overall drug usage from patient medical data obtained by the data management database may be compiled and displayed in aggregate form such that a user can readily identify the total number of patients utilizing a particular drug. By aggregating the patient medical record data and corresponding physician information, a purchaser is able to readily identify overall trends and statistics in the patient medical record data without having to sort through raw patient medical data. The aggregated patient medical record data enables a purchaser to efficiently evaluate patient medical record data and its usefulness to the purchaser without requiring the purchaser to review each individual patient medical record individually.

The figures described above are intended to illustrate the concepts of the system of the present disclosure. Standard computer programming techniques using various computer programming languages are used to search and filter patient medical record data and no particular apparatus or programming method is intended by the words describing the figures or the figures themselves. For example, while the concept of filtering might be understood and illustrated as forcing data through a particular module, it is also understood that filtering may occur by various other techniques such as indexing the patient medical record data and selecting data based on indexing of the data.

While a system is described wherein the medical record data is filtered at the data management system 16, it is also understood that filtration and authorization of the medical record data could occur locally at the healthcare provider database 14. By filtering the patient medical record data 12 locally, the data management database 16 is not required to store medical record data but instead acts as a conduit for sending purchaser requests to healthcare provider databases 14 and relaying the filtered and authorized medical record data to the purchaser. It is also understood that filtration only may occur locally with the data management database authorizing the information, or vice versa.

The de-identified medical record data may be assigned a purchase price based on a number of factors. All medical record data associated with a particular healthcare provider may be assigned a price based on factors such as the healthcare provider's specialty, location, procedure, the number of medical records provided to the data management database by the healthcare provider, and other factors. Alternatively, the de-identified medical record data may be assigned a purchase price based on patient factors such as the patient diagnoses, medications, procedures, age, treating physician, location, and other factors. Further, the patient or healthcare provider may assign a desired price for each of their corresponding medical record data. Medical record data may also be assigned a price based on the allowed usage of the patient medical record data designated by the patient or healthcare provider. For example, if a healthcare provider tags the medical record data as available for purchase by a single industry member, then the medical record data would be assigned a different value than medical record data available for purchase by multiple industry members.

The healthcare provider or patient corresponding to the medical record may set a desired price for the de-identified medical record. The de-identified medical record data may be auctioned to one or more authorized industry groups, wherein one or more of the industry groups bid on the exclusive use of the de-identified medical record data corresponding to the particular healthcare provider(s) or patient(s).

To access the full medical record data returned in the search, the purchaser submits a payment for the data based on the value of the data designated in the data management system. The purchaser is billed for each individual medical record or report that the purchaser desires to obtain. The purchaser may pay a monthly subscription fee for access to a designated number of medical record data or reports over a specified period of time.

After the purchaser has remitted payment to the data management database, a portion of the payment is allocated to the provider of the sold data (i.e. healthcare provider, healthcare practice, or patient) for future remuneration. The portion of the payment allocated to the healthcare provider, healthcare practice, or patient corresponding to the sold healthcare record is based on the value of the medical record that was sold. The patient may also receive a portion of the payment for the patient's de-identified medical record after it is sold.

Payment to the provider of the sold data may be based on the number of healthcare records purchased and the number of healthcare records sold. The data management database tracks the number of records received from each provider. The data management database further tracks the number of records that are sold that were received from each provider, thereby allowing accurate payment of each provider of healthcare records based on the number of records sold that can be attributed to each provider.

Payment to the provider of the sold data may also be based on information contained within the healthcare record provided. For example, a full clinical examination record may have a higher value than a record of results for a single lab test of a patient. The data management database may analyze each healthcare record to determine the contents of the healthcare record and assign a value to be transmitted to the provider based on the contents of the healthcare record. Various diagnostic codes (e.g. ICD-9 codes), healthcare procedure codes (e.g. current procedure terminology (CPT) codes), drug utilization, medical device utilization, outpatient prescription information, or character recognized text from the medical record are analyzed by the data management database. The contents of the healthcare record are then assigned a price based on the value of each item in the healthcare record. For example, each procedure code may be assigned a first value while drug or medical device utilization may be assigned a second value. Payment to the provider may be based on the total price of the content of the healthcare record or, alternatively, may be based on each item in the healthcare record used. If a purchaser only desires to obtain healthcare data related to the utilization of a particular drug, then the provider is compensated based on drug utilization that is transmitted to the purchaser from healthcare records corresponding to the particular provider.

The amount of the payment to the healthcare provider may be determined using other various embodiments. For example, regulations may require that each healthcare provider be compensated equally for the sale of their related patient medical record data. In one method, multiple sub-databases are contained within the data management database, with each sub-database corresponding to a particular healthcare provider specialty such as retina specialists, dermatologists, and other various specialties. Each sub-database may be sold to one or more purchasers as authorized by the one or more healthcare providers according to the present disclosure. A percentage of the revenue from the sale of a particular sub-database is allocated to the healthcare providers having data corresponding to the particular sub-database such that the revenue is divided equally among the healthcare providers, thereby ensuring that each healthcare provider is compensated equally.

In one embodiment, healthcare providers may be compensated for their corresponding medical record data sold through the data management database by multiplying revenue of data sold over a given period of time by a royalty rate and dividing that amount by the number of healthcare providers. Healthcare provider authorization of their medical record data to be sold may also be accounted for by multiplying the revenue over a given time period by the royalty rate and then dividing that amount by the number of healthcare providers who contributed medical record data to the particular database and authorized their data to be sold. Further, various discounts on electronic health record vendor fees, drug inventory system fees, practice management and billing system fees, healthcare society membership fees or dues, healthcare society data registry fees, and other discounts or rebates may be applied to the healthcare provider.

As an example, if 200 healthcare providers contribute data to a particular sub-database and $1,000,000 is generated from selling the data corresponding to the particular sub-database with a 10% royalty to be paid to the particular healthcare providers, then each healthcare provider will receive compensation of $500 (10% of $1,000,000 split equally among the 200 healthcare providers).

In another embodiment, payment to the one or more healthcare providers may be calculated by multiplying the revenue over a given time period generated by the sale of medical record data from a particular healthcare provider by a royalty rate with that amount being paid to each of the one or more healthcare providers such that each of the healthcare providers is compensated based on revenue generated from their medical record data.

In yet another embodiment, payment to the one or more healthcare providers is calculated based on the number of patient encounters with a particular healthcare provider. The number of encounters provided by a particular healthcare provider is divided by the total number of encounters in the data management database from all healthcare providers. The revenue for a given time period is multiplied by a percentage revenue to be provided to healthcare providers as shown below:

Provider A Payment=(encounters provided by Provider A)/(total encounters in database)×(percentage of revenue allocated to providers)

Patients may have the option to “opt-in” to the data management database. When a patient visits a healthcare provider for treatment, the treating healthcare provider or healthcare provider may notify the patient that, if the patient desires, their medical record data may be sold to various industry members. The patient may authorize one or more industry groups for purchasing their medical record data. Alternatively, a patient's medical record data may be obtained directly from the patient and the patient is compensated directly based on the sale of their medical record data.

The data management database may compile large numbers of medical records affiliated with various healthcare providers and various specialties. In some instances, the data management system will produce a larger quantity of medical records than a purchaser desires to purchase. For example, a purchaser may desire to purchase only 1,000 personal medical records out of a total of 100,000 medical records located during a search. The 1,000 medical records may be affiliated with 10 particular healthcare providers. The data management system will compensate those healthcare providers for their medical records. While those 10 healthcare providers are compensated for their shared medical records, the other healthcare providers affiliated with the medical records that were not purchased by the purchaser are not compensated.

Therefore, the data management system will maintain a record of the number of times a healthcare provider's data has been purchased by a purchaser. When a purchaser desires to obtain only a portion of filtered search results from the data management system, the data management system will determine which healthcare providers have sold more data than other healthcare providers and will select medical records affiliated with healthcare providers that have sold less medical record data than other healthcare providers, thereby spreading purchases of medical record data across multiple healthcare providers. The data management system may track the number of times a healthcare provider's data has been sold across all healthcare providers, or alternatively may track and compare the number of times a healthcare provider's data has been purchased across a particular specialty, geographic area, or other identifying criteria.

Similarly, when the data management database aggregates patient medical record data from multiple third party EHR vendors as described above, patient medical data purchases are tracked to ensure that data purchases are spread across the one or more multiple third party EHR vendors. The data management database may compile a large amount of patient medical record data from the one or more third party EHR vendors.

For example, the data management database may aggregate patient medical record data from three third party EHR vendors. A purchaser may only want to purchase patient medical record data corresponding to 1,000 macular degeneration patients out of a potential 1,000,000 macular degeneration patients aggregated from the three EHR vendors. The patient medical record data corresponding to the 1,000 desired records may only come from two of the three EHR vendors. If the EHR vendors are compensated based on patient medical record data sold, then the third EHR vendor may miss out on the opportunity to be compensated for its corresponding patient medical record data.

The data management database tracks the number of times patient medical data is purchased from a third party EHR vendor to ensure that each of the three third party EHR vendors in the example above has the opportunity to sell patient medical record data and to prevent only a limited number of the third party EHR vendors from being the only vendors to sell patient medical record data.

The data management database may select patient medical record data such that each of the third party EHR vendors has an equal number of patient medical record encounters sold or, alternatively, may select patient medical record data such that the number of records sold corresponding to each third party EHR vendor is proportional to the amount of patient medical record data provided by each individual third party EHR vendor. For example, if the data management database contains patient medical record data corresponding to 10,000 patient encounters with healthcare providers, 4,000 of which were provided by a first EHR vendor, 5,000 from a second EHR vendor, and 1,000 from a third EHR vendor, then patient medical record data from the first EHR vendor may be sold 40% of the time, patient medical record data from the second EHR vendor may be sold 50% of the time, and patient medical record data from the third EHR vendor may be sold 10% of the time.

The data management database may automatically balance the amount of patient medical record data sold corresponding to individual third party EHR vendors either across all patient medical record data obtained and sold by the data management database or across patient medical record data corresponding to a subset of the overall patient medical record data. For example, the data management database may automatically balance the amount of patient medical record data sold corresponding to each third party EHR vendor for all patient medical record data for patient encounters related to endocrinologists, orthopedic surgeons, or other various subsets of the patient medical record data.

Healthcare providers may be compensated for the sale of their patient medical record data by transferring money directly to the healthcare provider. Other forms of compensation may include discounts on services healthcare providers purchase rather than direct compensation. For example, if a healthcare provider authorizes a third party EHR vendor who manages the healthcare provider's patient medical record data to sell the healthcare provider's data, the healthcare provider may receive a discount on their EHR regular fees, maintenance fees, purchase price, and other associated costs. The discount may be in the form of percentage reduction in fees, a dollar amount reduction, an annual rebate, and other like forms of compensation or discounting. The discount may vary based on the number of customers a healthcare provider authorizes for purchasing their patient medical record data.

The discount may further apply to a healthcare provider's practice management software fees, maintenance fees or purchase price, in-office drug inventory system software fees, maintenance fees or purchase price, healthcare society membership fees or dues, and healthcare society data registry fees.

In one embodiment, insurance companies may use healthcare provider authorization for claims data sales and provide higher reimbursement rates or other compensation for healthcare providers who allow their patient medical record data to be sold.

In yet another embodiment, drug distributors may use healthcare provider authorizations for selling practice sales information such as how much drug a particular healthcare provider practice purchased to tie the authorizations to higher rebates or lower prices or other forms of compensation to the healthcare provider.

Invoicing, accounting and sales data from the system for managing healthcare data are communicated with an invoicing and accounting system of the third party EHR vendors, practice management software vendors, in-office drug inventory system vendors, health insurance payers, healthcare societies, and drug distributors. Revenue from patient medical record data sales tied to a particular healthcare provider are then automatically communicated to invoicing and accounting systems of the above entities so that any discounts, rebates, payments or other compensation may be calculated and applied to invoices from the entities to the healthcare provider.

### Healthcare Provider and Patient Control of Medical Record Data

The data management system provides healthcare providers and patients with greater control over medical record data they are associated with. Further, the data management system incentivizes physicians and healthcare providers to provide complete and accurate medical record data to purchasers. Because the value of medical record data associated with a particular healthcare provider is determined based on the factors described above, healthcare providers that provide more complete records may be paid a greater amount for each medical record sold corresponding to that healthcare provider.

To provide greater control over medical record data associated with a particular healthcare provider, the data management system may assist the healthcare provider in opting out of public databases that allow third party data miners to obtain information related to the healthcare provider without the healthcare provider's consent. For example, the American Medical Association maintains a “Masterfile” containing information on physicians, medical students, and residents within the United States. A record for a particular physician is created in the Masterfile when the physician enters an accredited medical school or residency. Physicians may be added to the Masterfile by default, and in some cases may even be unaware of their inclusion in the Masterfile. The AMA may then license access to the Masterfile to various third parties, thereby providing information on the physician to be used with data mining and other techniques in an attempt to correspond medical record data to a physician. For example, every physician in the Masterfile has a corresponding identification number. Data such as prescription data from a pharmacy may be sold and identified with a relevant physician based on the identification number. The physician has no control over who has access to their prescription and Masterfile information, and thus may be subject to marketing and other unwanted solicitations based on this information.

To provide the healthcare provider with greater control over their associated medical record data, the data management system compiles physician information while assisting the healthcare provider to opt-out of publicly available databases such as the Masterfile. The Physician Data Restriction Program allows physicians to “op-out” of the Masterfile and thereby restrict their information from reaching third parties such as pharmaceutical companies. When a healthcare provider or healthcare provider practice registers to provide information to the data management database, the database may automatically inform the healthcare provider or healthcare provider practice of their ability to opt-out of the Masterfile, and if the healthcare provider consents, automatically send a request to the AMA to opt the particular physician(s) out of the Masterfile.

The data management system pulls physician information from the Masterfile and assigns healthcare providers in the data management system a unique identification number separate from the healthcare provider's Masterfile identification number. Other information may be added to a physician's information including the physician's age, practice size, practice structure, and geographic information.

Therefore, after a healthcare provider has opted out of the Masterfile, the present system allows a physician to control which relevant industry members have access to their associated personal medical record data. Personal medical record data in the data management system is sold to third parties in the relevant industry groups that are authorized by each physician. If a healthcare provider desires that their associated medical record data only be used for research purposes, the healthcare provider may designate their associate data as only transferable to research institutions.

The data management system also incentivizes healthcare providers within the system to provide complete medical record data to the data management system. By compensating the healthcare provider based on the quality of the information sold affiliated with a particular healthcare provider, each healthcare provider is encouraged to participate in sharing the medical record data. Additionally, because the medical record data is compiled directly from a medical practice database, the data management system is not required to attempt to associate obtained medical record data with a particular healthcare provider.

When a physician or healthcare provider elects not to participate in the sale of personal medical data affiliated with the physician or healthcare provider, the physician or healthcare provider does not tag any relevant industry groups as authorized to view the patient medical data. Alternatively, a physician or healthcare provider may have the option of tagging the personal medical data as private, thereby preventing the information from being sold to any industry groups. When patient medical data is received from a physician or healthcare provider and tagged as not for sale, the data management system may not analyze or otherwise process the patient medical data.

If a healthcare provider elects to opt-out of the sale or sharing of their affiliated personal medical data, generic information regarding the healthcare provider may still be collected to be aggregated with information regarding other healthcare providers or otherwise displayed in reports generated by the data management system. Generic information on a healthcare provider may include the size of the healthcare provider, the healthcare provider's specialty, whether the healthcare provider is an academic or private practice, whether the healthcare provider is in an urban or suburban location, or other relevant information on the healthcare provider. The healthcare provider information may also be obscured or “blurred” such that a purchaser is able to view broad information such as the healthcare provider's state, first three digits of the healthcare provider's zip code, the pharmaceutical marketing territory division, the pharmaceutical marketing territory division, and other geographic information such that the purchaser is able to determine where the healthcare provider is located without revealing the identity of the healthcare provider to the purchaser.

The level of blurred information on a healthcare provider may vary depending on the number of other similar healthcare practices in a given geographic area or other factors. The data management system may automatically blur the geographic identification of the healthcare provider to a pre-determined level that corresponds to a certain number of providers in the healthcare provider's particular geographic area.

For example, if the data management system displayed geographic information for 50 or more healthcare providers in a specific specialty, the geographic area will be bigger for rural areas compared to urban areas. In a rural area or smaller city there will be fewer healthcare providers in a given specialty, and in some instances there may only be one or two healthcare providers in a given specialty. If a search returns blurred information about the healthcare provider in the rural area or small city, a purchaser may be able to determine the identity of the healthcare provider that desired to remain anonymous. Therefore for rural areas, small cities, or other areas that include a limited number of healthcare providers, the data management system automatically blurs the geographic location information of a healthcare provider such that there are a minimum number of other healthcare providers in the geographic area. Depending on the minimum number of other healthcare providers, the geographic information may be blurred by various levels such as zip code, county, state, and regional levels.

The data management database may further allow patients to authorize use of their patient medical data, such as where patient authorization is required by law or regulations. Patients may authorize their patient medical records for use by the data management database for all uses, for no uses, or may individually select certain uses as desired by the patient.

In one example, a healthcare provider requests authorization from that particular healthcare provider's patients. The healthcare provider may then provide a list of authorized patients to the data management database, or may provide a list of patients who have declined to authorize the use of their patient medical record data. The healthcare provider may further designate in the list the specific uses the healthcare provider's patients have authorized their medical record data to be used, such as for research or commercial use. In one example, the data management database assumes that all patients have authorized their medical record data for all uses. Alternatively, the data management database may assume by default that all patients have declined authorization unless otherwise provided by the healthcare provider. The healthcare provider may be responsible for maintaining the list of authorizations by its patients if a patient decides to opt-out or opt-in to sharing their medical record data.

The list is stored in the data management database and a relationship between the healthcare provider and patients associated with the healthcare provider is maintained by the data management database. When the data management database subsequently receives patient medical record data from the healthcare provider, the patient medical record data is analyzed against the list of authorized patients from the healthcare provider. If a patient medical record is received corresponding to a patient who has not authorized their patient medical record data for all uses, the patient medical record is tagged by the data management database designating that patient as having opted out of sharing their medical record data.

When a medical record has been tagged as not authorized for use, the medical record may be deleted, stored but segregated from authorized medical records such that if a patient authorizes their medical record data for use the stored record may transmitted by the data management database, or tagged such that the record is only shared for authorized uses.

### Postmarketing Surveillance and Medical Record Analysis

Patient treatment history and responses to particular procedures or medications may also be compiled using the data management system. The data management system is used in conjunction with Food and Drug Administration (“FDA”) and other U.S. and international governmental agencies and non-governmental monitoring bodies postmarketing surveillance of a particular drug or medical device. Postmarketing surveillance is an important step in the FDA approval process for drugs and medical devices, wherein the FDA continues to monitor drugs and medical devices after preapproval studies to detect any adverse events associated with the drug or medical device when the product is placed on the market. In current FDA postmarketing surveillance, adverse events are typically voluntarily reported to the FDA.

By compiling detailed medical information from various healthcare providers and medical practices including patient medical histories and updated patient medical record data for subsequent patient visits to the physician, the data management system provides information allowing detailed postmarketing surveillance of particular drugs or medical devices. The personal medical record data collected by the data management database may be aggregated based on patients taking a particular drug or utilizing a particular medical device. Personal medical record data collected are aggregated based on a patient's diagnoses, such as a diagnoses using a standard classification code such as ICD-9. Personal medical record data may be aggregated based on clinical findings from a patient's examination such as blood pressure measurements and other lab values. The aggregated personal medical record data are then analyzed to determine whether certain clinical findings or diagnoses occurred with a greater frequency than other patients having personal medical record data in the database that were not on the particular drug or using the particular medical device. For example, the data management database may aggregate data from patients on a particular drug to determine whether heart attacks occur with greater frequency among patients taking the particular drug versus patients not taking the particular drug. This process may be used to spot specific trends of side effects related to particular drugs or medical devices.

The data management system monitors patients and their personal medical record data collected by the system after a patient begins taking a particular drug or utilizing a particular medical device. The patient's diagnoses at the time the patient begins to take the particular drug or use the particular medical device are analyzed and compared to subsequent diagnoses after beginning to use the drug or medical device. For example, a patient's medical record data may show a preliminary diagnosis of hypertension and arthritis at the time of being prescribed a particular drug to treat those conditions. Subsequent visits and related medical record data may show that the patient suffered a heart attack. As a result, the data management system would tag the diagnosis revealing a heart attack and aggregate the diagnosis with those of similar patients who also were prescribed the particular drug within a recent period of time and suffered a heart attack. This process would evaluate patient symptoms and conditions after having started a new drug for treatment.

A pharmaceutical manufacturer or the FDA may evaluate the side effects of drugs by focusing on particular known side effects discovered during the approval process. For example, if during the approval process a slightly increased risk of a heart attack was found when using a particular drug but the risk was not found to be enough to reach clinical significance, the pharmaceutical manufacturer and FDA may continue to monitor the drug using the data management system. The drug company or FDA may create an account with the data management system and designate a particular diagnosis to monitor, such as patients suffering from heart attacks while taking a particular drug. The data management system may thus be used to monitor for a specific diagnosis rather than examining trends in patient diagnoses.

By enabling postmarketing surveillance of drugs and medical devices, the data management system allows close monitoring of the drugs and medical devices after being placed on the market. While the FDA process of approving drugs and medical devices is somewhat stringent, it is impossible to detect all possible side effects because clinical trials are performed on a relatively small number of patients for a relatively short period of time. The data management system allows a large number of patients to be monitored with respect to their symptoms and side effects from using a particular drug or medical device, thereby providing more accurate analysis of postmarketing surveillance as opposed to voluntary and self-reported events.

The data management database also allows a study sponsor, such as a pharmaceutical company or medical device manufacturer, to screen healthcare providers to locate particular healthcare providers for inclusion in clinical trials. The study sponsor may screen healthcare providers using the data management database based on a number of variables, for example the number of a healthcare provider's patients with specific diagnoses needed for trial recruitment. The study sponsor enters a desired set of criteria into the filter module of the data management database to review patients corresponding to the particular healthcare provider that meet the criteria designated by the study sponsor. Healthcare providers that meet the screening criteria are then displayed to the study sponsor as well as identifying healthcare provider information stored in the data management database such as location, physicians, and other identifying information. Alternatively, healthcare providers that meet the screening criteria may be displayed to the study sponsor in a de-identified manner and the data management database would then provide the provider identification to a third party for a further evaluation such that the provider identification is not immediately disclosed to the study sponsor. The data management database may screen users attempting to register as study sponsors to verify that the user is in fact a study sponsor to prevent any unwanted marketing to healthcare providers.

In one embodiment, patient medical record data affiliated with patients enrolled in a clinical trial may be removed from the data management database or otherwise made unavailable to purchasers during the clinical trial to prevent purchasers from prematurely obtaining and viewing patient medical record data before the clinical trial is completed. A clinical trial reference table may be maintained within the data management database, the clinical trial reference table including the names of any drugs or devices used in conjunction with a particular or any clinical trial. Alternatively, the healthcare provider of clinical trial sponsor may provide a list of patient names or other identifying information and those names may be used to populate a clinical trial reference table. If patient medical record data is received that contains data related to treatment involving the particular drugs or medical devices or patients enrolled in a clinical trial, the patient medical record data may be screened or otherwise withheld from other patient medical record data. In another embodiment, the healthcare provider may tag patient medical record data as corresponding to a particular clinical trial or any clinical trial before transmitting the patient medical record data to the data management database and the patient medical data is subsequently withheld from purchasers or other entities utilizing the data.

The data management database also allows a sponsor, such as a pharmaceutical company or medical device manufacturer, to screen healthcare providers to locate particular healthcare providers for surveys, chart reviews, interviews, or other evaluations and research. The sponsor may screen healthcare providers using the data management database based on a number of criteria, for example the number of a healthcare provider's patients with specific diagnoses, the healthcare provider's drug or procedure utilization, provider demographics, or other criteria. The sponsor enters a desired set of criteria into the filter module of the data management database to review healthcare providers that meet the criteria designated by the entity. Healthcare providers that meet the screening criteria are then displayed to the sponsor as well as identifying healthcare provider information stored in the data management database such as location, physicians, and other identifying information so that those providers can be contacted for the additional evaluation. Alternatively, healthcare providers that meet the screening criteria may be displayed to the sponsor in a de-identified manner and the data management database would then provide the provider identification and contact information to a third party for completion of the additional evaluation (surveys, chart reviews, interviews, other evaluations and research), such that the provider identification is not disclosed to the sponsor. The third party would complete the additional evaluation and provide the results to the sponsor in a de-identified fashion.

The data management database may also be utilized by insurance companies to compare physician utilization. Specifically, insurance companies can compare how much one physician spends taking care of a patient having a particular diagnosis relative to another physician treating a patient with the same diagnosis. Patient medical record data may be collected indicating the number of prescriptions written by a particular healthcare provider for a given period of time. The number of prescriptions and type of prescriptions written by the particular healthcare provider are cross-referenced with existing information including the average retail cost of a particular drug to provide a report on the total prescription costs attributable to that particular healthcare provider. Prescription data in the healthcare database for a particular healthcare provider may also me associated with clinical data in the healthcare database for a particular provider to provide a report on prescription drug usage associated with specific conditions for that particular provider.

Insurance companies and Accountable Care Organizations may also utilize the data management database to audit physician practice patterns. The insurance company or Accountable Care Organization may submit a request for all records for a particular healthcare provider from the data management database. Alternatively, the insurance company or Accountable Care Organization may submit a request for all patient records from patients with a specific type of insurance coverage or a specific insurance carrier.

The data management database also monitors patient medical record data that is transmitted or pulled from healthcare databases to look for irregular variations in the patient medical record data. For example, if variation is detected in patient medical record data obtained by the data management database, that particular record is flagged for manual review of the patient medical record data. For example, if medical record data related to a patient's blood pressure is collected and observed to be 120/80 for a given period of time, and subsequently patient medical record data is received indicating a blood pressure of 250/120 for one month, that entry would be automatically flagged as an outlier for manual review. In another example, if a healthcare provider has 100 patients with a blood glucose of between 120-150, and an entry is received for blood sugar recorded at a level of 600, the entry would be flagged for manual review. Manual review may include human review of the patient's medical chart to confirm the patient's medical data for the abnormal entry. The level of variation required for flagging an entry as abnormal may be adjusted, such as a desired variation of 50% for blood pressure or other desired variations for other patient medical record data.

In another aspect the data management database identifies one or more patients suitable for participating in a healthcare-related survey based on the patient's particular medical record data. For example, pharmaceutical companies often survey patients that have certain conditions or who are taking certain drugs and compensate patients for completing the surveys. The data management database may use patient medical record data obtained by the data management database from the various healthcare providers to identify various patients that a survey provider, such as a pharmaceutical company, desires to survey. The survey provider inputs desired characteristics into the data management database, such as age, gender, medication usage, diagnosis, and geographic area.

After receiving the desired characteristics from the survey provider, the data management database identifies patients matching the desired characteristics and further identifies the patients' healthcare providers. The data management database then communicates with the healthcare provider database to flag those patients within the healthcare provider database as patients desirable for completing the survey.

When a patient is flagged as a desirable patient for completing a survey, the data management database may pre-populate certain data fields of a survey for desired patients based on that patient's medical record data obtained by the data management database. The pre-populated survey may be transmitted to the healthcare provider database and provided to the patient when the patient visits the healthcare provider. After completing the survey, the healthcare provider or patient may then transmit the survey to the data management database where the survey results are then transmitted to the survey provider.

By acting as an intermediary between survey providers and healthcare providers, the data management database allows survey providers to quickly locate patients having desired characteristics for a particular survey, and further to administer the survey to the desired patients. The patient may also submit personalized identification information such as their name and address to receive remuneration for completing the survey. The data management database may remove all identifiable information for the particular patient before transmitting the survey results to the survey provider, but maintain the identifiable information for transmitting remuneration from the survey provider to the patient. The data management database may transmit remuneration to the patient, such as providing either direct payment to the patient or alternative compensation such as a gift card, discount coupon for a particular drug, discount on physician co-pay or deductible, or other alternative compensation.

The healthcare provider may print out a survey pre-populated by the data management database for the patient to complete. Alternatively, the survey may be transmitted to the healthcare provider electronically for the patient to complete. For example, the healthcare provider may provide the patient with a terminal, such as a tablet or personal computer, to complete while the patient waits to see a physician at the healthcare provider. With portions of the survey pre-populated with general information regarding the patient, the patient may then complete the survey. After completing the survey, the patient may submit the survey electronically using the terminal. The completed survey may either be transmitted to the healthcare provider database which then transmits the completed survey to the healthcare management database or, alternatively, the terminal may be in direct communication with the data management database. In another alternative, the patient may be provided with a link or code to be scanned with a smartphone for directing the patient to an online form for completing the survey. In yet another alternative, the survey or a link to complete the survey may be e-mailed directly to the patient from either the healthcare provider database or the data management database.

The data management database links healthcare providers and survey providers such as pharmaceutical companies for surveys regarding drug utilization, the number of patients seen in a given time period with certain diagnoses, anticipated future drug utilization, and motivation for utilization of a particular drug. The survey provider enters desired healthcare provider information into the filter module of the data management database to locate one or more healthcare providers suitable for a survey. The survey may be issued to the healthcare provider from the data management database, and further the healthcare provider may be compensated for participating in the survey.

The completed survey is then transmitted to the survey provider. The data management database retrieves information regarding the specific healthcare providers responding to the survey and a report is prepared showing data from the responding healthcare providers. By providing both data corresponding to responding healthcare providers in connection with a survey, a survey provider is able to link healthcare provider utilization data to healthcare utilization survey responses.

### Healthcare Provider and Healthcare Facility Rankings and Benchmarking

The data management system may be used to evaluate the performance of healthcare providers corresponding to personal medical record data collected in the data management system. Clinical outcomes for healthcare providers are analyzed and compared to other patient medical record data. For example, visual acuity may be measured subsequent to a particular procedure for a particular ophthalmologist and compared to other ophthalmologists corresponding to other medical record data in the database. If a significant variation is detected from the database average, a particular healthcare provider may be flagged and brought to the attention of the appropriate license holder or insurance company as below average. Further, the data management system may also flag physicians that have above average clinical outcomes.

Individual healthcare providers or healthcare providers may be assigned a “score” by the data management system to help pharmaceutical companies to assess the “value” of particular healthcare providers. Healthcare providers having higher scores may designated as high-value targets for pharmaceutical companies such that the pharmaceutical companies focus on high-value healthcare providers for marketing pharmaceutical products. The healthcare provider's score may be based on the total number of patients seen, total number of patients with a specific diagnosis or diagnoses seen, total number of prescriptions written, total number of prescriptions for a single medication or class of medications, and the total value of those prescriptions within a designated period of time. Healthcare providers may also be assigned a score for medical device manufacturers based on the total number of patients seen, the total number of patients seen for a specific diagnosis, the total number of surgeries performed for a diagnosis or diagnoses, the total number of surgeries performed, or the total number of specific devices utilized in a given year by device class or brand within a designated period of time. Healthcare providers may be assigned an overall score or a physician may have multiple scores corresponding to certain categories of drugs and medical devices. Healthcare providers may also have scores for the various subcategories described above or other relevant subcategories.

The score assigned to a physician by the data management system may also control the value of the medical record data corresponding to a particular healthcare provider. Medical record data corresponding to a healthcare provider having a higher score based on the above factors may be more valuable than medical record data corresponding to a healthcare provider having a lower score. Therefore the value assigned to medical record data corresponding to a particular healthcare provider may be based on the score assigned to a healthcare provider as described above.

Physicians and healthcare providers may be assigned a score by the data management system to help patients assess particular physicians and healthcare providers for treatment. Physicians and healthcare providers may be assigned a score based on the factors described above and further based on clinical outcomes of patients based on procedures performed by the physicians or healthcare providers. Potential patients may search the data management system for a particular physician to determine that healthcare provider's score and compare that score to other physicians. Patients may also search for physicians with the top scores in a particular field and by geographic region.

Physicians and healthcare providers may use data from medical record data in the data management system to compare their practice to other practices in the region and nationwide. For example, healthcare providers in a particular practice can compare statistics such as number of patients seen, number of diagnoses, treatment outcomes, and other factors with the aggregate average of healthcare providers within the same region. Further, the particular practice can compare their statistics to national averages, allowing physicians to compare their practices to regional and national averages. Physicians and healthcare providers may only be allowed access to regional and national aggregate data if the physicians or healthcare providers share data with the data management system.

When healthcare providers are provided a report detailing their score and other benchmarking results, information compiled in the data management database may further be used to target advertising to a particular healthcare provider. One or more pharmaceutical companies or medical device manufacturers may purchase advertisements to be presented to the healthcare providers with the advertisements being targeted to the particular healthcare providers.

In one example, healthcare providers are targeted for advertisements based on the healthcare providers' utilization. The healthcare provider's utilization is determined based on the one or more patient medical records obtained by the data management database from the healthcare providers. For example, if a healthcare provider utilizes large amounts of cholesterol medications then advertisements related to cholesterol medications would be provided to the healthcare provider. As another example, if medical records associated with the healthcare provider demonstrate regular treatment of depression, then depression medication related advertisements may be provided to that particular healthcare provider.

In an alternative, healthcare providers may be targeted for advertisements based on the healthcare providers' demographics as provided to the data management database by the healthcare providers. Demographic information such as age, specialty, practice type, geography, and other relevant demographic information are compiled from patient medical records and information provided by the healthcare providers as disclosed above. The demographic information is analyzed and one or more targeted advertisements may be presented to the healthcare providers based on their demographic information. For example, cardiologists would be presented ads for cholesterol drugs, while rheumatologists would be presented ads for arthritis drugs.

Advantages of the healthcare data management system include providing a system and database for a purchaser to locate specific patient medical record data and compensating the relevant healthcare provider and/or patient for the sale of the patient medical record data. Further, healthcare provider information may be associated with the patient medical record data thereby enhancing a purchaser's understanding of both the patient medical record data and the relevant treating healthcare provider.

Embodiments of the healthcare data management system also enable the system to passively receive data from healthcare providers instead of actively pulling data from healthcare provider databases. By configuring the healthcare data management system to be the recipient of patient medical record data “pushed” by healthcare providers, the healthcare data management system automatically receives patient medical record data whenever new patient medical record data is entered into a healthcare provider database or whenever existing patient medical record data is updated. Passively receiving data automatically pushed to the data management system from healthcare providers allows the data management system to efficiently handle large numbers of documents rather than actively requesting updated medical records.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

1. A method for aggregating and distributing healthcare information, wherein healthcare information corresponding to a plurality of patients and a plurality of healthcare providers is stored in a computer database implemented on one or more computers, the computer database including hardware, software and electronic data, each item of healthcare information being associated with a patient and at least one healthcare provider, the healthcare information including identifying information that identifies the associated patients and the associated healthcare providers; the method comprising:
establishing communication between the computer database and a purchaser;
computer generating de-identified healthcare information that is aggregated from the healthcare information in the computer database and includes at least some of the healthcare information but does not include certain identifying information relating to at least one of the patient identities and healthcare provider identities;
storing at least a portion of the de-identified healthcare information in the computer database;
in response to a purchaser request, communicating requested information that is based on at least a portion of the de-identified healthcare information from the computer database to the purchaser; and
computer calculating compensation for one or more of the healthcare providers and patients based in part upon at least one of the requested information and the de-identified information.

2. The method of claim 2 wherein healthcare information is stored in a plurality of first computer databases implemented on computers, each first computer database including hardware, software and electronic data, the method comprising:
establishing communication between the first computer database and a broker computer database implemented on a computer; the broker computer database including hardware, software and electronic data;
establishing communication between the broker computer database and a purchaser;
computer generating de-identified healthcare information that is aggregated from the healthcare information in the plurality of first computer databases and includes some of the healthcare information but does not include certain identifying information;
storing at least a portion of the de-identified healthcare information in the broker computer database;
in response to a purchaser request, communicating requested information that is based on at least a portion of the de-identified healthcare information from the broker computer database to the purchaser and storing usage information based on the requested information provided to the purchaser;
based on the usage information, computer calculating compensation for one or more of the healthcare providers and patients.

3. The method of claim 2 further comprising:
communicating a purchaser request for information from a purchaser to the broker computer database;
in response to the purchaser request, the broker computer database generating a broker request for information from at least one of the first computer databases;
in response to the broker request, the first computer database communicating selected de-identified healthcare information from the first computer database to at least one of the purchaser and the broker database.

4. The method of claim 2 wherein the selected de-identified healthcare information is transmitted directly from the first computer database to the purchaser.

5. The method of claim 1 further comprising:
assigning a value to individual items of de-identified healthcare information based in part upon one or more factors selected from healthcare provider factors and patient factors, and
charging a fee to purchasers of de-identified healthcare information based on its assigned value.

6. The method of claim 1 further comprising calculating compensation to healthcare providers and patients based in part on one or more factors selected from healthcare provider factors and patient factors.

7. The method of claim 1 further comprising controlling the de-identified healthcare information that is supplied to purchasers so that the purchased de-identified healthcare information is distributed across the patients and healthcare providers based upon predetermined fairness criteria.

8. The method of claim 7 wherein the fairness criteria is selected from (1) equal distribution of purchases among healthcare providers and (2) distribution of purchases among healthcare providers in proportion to the amount of de-identified healthcare information provided by each healthcare provider.

9. The method of claim 1 further comprising further comprising compensating at least one of the healthcare providers and the patients by indirect compensation selected from the group of discounts, rebates, increased reimbursement for service, and combinations thereof.

10. The method of claim 1 wherein the compensation of the health care providers is limited to a cap to insure that the compensation does not exceed the fair market value of the healthcare information.

11. The method of claim 1 further comprising:
providing a first industry with first information corresponding to the de-identified data and generating revenue from the first industry based on the first information provided;
providing a second industry with second information corresponding to the de-identified data and generating revenue from the second industry based on the second information provided;
calculating compensation for healthcare providers based on revenue from the first
industry and limiting the calculated compensation to a cap for the first industry;
calculating compensation for the healthcare providers based on revenue from the second industry without limiting the calculated compensation to a cap.

12. The method of claim 1 wherein the de-identified healthcare information is provided by a defined group of healthcare providers and each healthcare provider in the defined group is compensated equally.

13. The method of claim 1 wherein the certain identifying information, which is not included in the de-identified healthcare information, comprises patient identifying information and further comprising:
creating a unique coded identifier for each patient that is coded such that the actual identity of a patient is protected;
storing the unique coded identifiers in association with each item of de-identified healthcare information so that all items of de-identified healthcare information of a particular patient include the same unique coded identifier, whereby a healthcare history for a particular patient may be assembled from the de-identified healthcare information based on the unique coded identifier for the particular patient without knowing the identity of the particular patient.

14. The method of claim 1 wherein the certain identifying information, which is not included in the de-identified healthcare information, comprises healthcare provider identifying information and further comprising:
creating a unique coded identifier for each healthcare provider that is coded such that the actual identity of a healthcare provider is protected; and
storing the unique coded identifiers in association with each item of de-identified healthcare information so that all items of de-identified healthcare information of a particular healthcare provider include the same unique coded identifier.

15. The method of claim 14 further comprising analyzing the de-identified healthcare information and creating a history corresponding to a unique coded identifier for a particular healthcare provider, whereby utilization and outcomes for an individual healthcare provider can be tracked over time without identifying the healthcare provider.

16. The method of claim 14 further comprising providing a report to a purchaser that includes the unique code with each item of de-identified healthcare information.

17. The method of claim 1 further comprising:
tagging the de-identified healthcare information with computer tags that identify the healthcare provider associated with each event reported in the de-identified healthcare information;
for each healthcare provider, designating in a computer whether or not a particular healthcare provider has or has not given permission to use healthcare information in the de-identified data,
including within the de-identified healthcare information only healthcare information for which the associated healthcare provider has given permission.

18. The method of claim 1 further comprising:
tagging a healthcare provider in at least one of the broker computer database and the first database with an opt-out tag in response to instructions from the opt-out healthcare provider;
programming at least one of the broker computer database and the first database not to include any healthcare information of the opt-out healthcare provider in the de-identified data.

19. The method of claim 1 further comprising:
tagging the de-identified healthcare information with computer tags that identify the patient associated with each event reported in the healthcare information;
for each patient, designating in a computer no desired groups, one desired group, or more than one desired groups who may receive de-identified healthcare information associated with a particular patient;
receiving a request from a specific purchaser in a specific group and identifying the specific group of the specific purchaser; and
based on the specific group of the specific purchaser, the computer tags and the desired groups designated for each patient, providing to the specific purchaser only the de-identified healthcare information designated for the specific group of the specific purchaser.

20. The method of claim 1 further comprising:
tagging the de-identified healthcare information with computer tags that identify the patient associated with each event reported in the de-identified healthcare information;
for each patient, designating in a computer whether or not a particular patient has or has not given permission to use healthcare information in the de-identified data,
including within the de-identified healthcare information only healthcare information for which the associated patient has given permission.

21. The method of claim 1, wherein:
the first computer database comprises a plurality of EHR computer servers of EHR vendors and wherein each item of de-identified healthcare information is tagged with an EHR tag to identify an EHR vendor, and further comprising:
based on the usage information and the EHR tags, computer identifying the each EHR vendor whose de-identified healthcare information was communicated to the purchaser and the number of healthcare providers of each EHR vendor in the de-identified healthcare information, and computer calculating compensation for each EHR vendor based on the de-identified healthcare information that was communicated to the purchaser or the number of healthcare providers of the E HR vendor represented in the de-identified healthcare information, or both.

22. The method of claim 1 further comprising:
tagging de-identified healthcare information in the broker computer database to identify clinical trial data from patients in clinical trials; and
programming the broker computer database to prevent access by purchasers who are not authorized to access clinical trial data.

23. The method of claim 1 wherein the healthcare information includes standardized interoperability documents containing a plurality of data elements and wherein the step of computer generating further comprises selecting data elements from one or more of the interoperability documents and storing the selected elements in the de-identified healthcare information.

24. The method of claim 1 further comprising:
computer analyzing the healthcare information to recognize specific diagnostic tests and to recognize numerical data in the specific diagnostic tests; and
storing in a computer the identity of recognized tests and recognized numerical data as separate data.

25. The method of claim 1 further comprising:
filtering the de-identified healthcare information with filter criteria to create a subset of de-identified healthcare information meeting the filter criteria, and
compiling and aggregating the subset into an aggregate report that provides information aggregated from a plurality of patients or events.

26. The method of claim 1 further comprising filtering the healthcare data based on filtering criteria selected by a purchaser and communicating to the purchaser only data that meets the filtering criteria.

27. The method of claim 1 further comprising:
computer analyzing the de-identified healthcare information to create designated information related to a particular healthcare item of interest, and
computer aggregating and analyzing the designated information and generating a postmarketing surveillance report that identifies effects and side effects of the healthcare item of interest.

28. The method of claim 1 further comprising:
computer analyzing the de-identified healthcare information to identify and select one or more of the patients and healthcare providers suitable for answering questions related to a particular subject;
pre-populating certain data fields in a survey based on the de-identified healthcare information corresponding to the selected ones of the healthcare providers and patients; and
transmitting the survey and a request to participate in the survey to the selected ones of the healthcare providers and patients.

29. A method for aggregating and distributing healthcare information, wherein the healthcare information is stored in one or more computer databases implemented on one or more computers, each computer database including hardware, software and electronic data, each item of healthcare information being associated with a patient and at least one healthcare provider, the healthcare information including identifying information that identifies the associated patients and the associated healthcare providers; the method comprising:
establishing communication between one or more of the computer databases and a purchaser;
generating de-identified healthcare information that is aggregated from the healthcare information in the one or more computer databases and includes some of the healthcare information but does not include certain identifying information;
storing at least a portion of the de-identified healthcare information in the one or more computer databases;
for each healthcare provider, designating in a computer one or more desired groups who may receive healthcare information associated with a particular healthcare provider;
determining a specific group for a specific purchaser;
providing the specific purchaser only with information corresponding to de-identified healthcare information associated with healthcare providers that have designated the specific group as a desired group;
charging a fee to purchasers who receive information corresponding to the de-identified healthcare information; and
computer calculating compensation for healthcare providers and compensating one or more of the healthcare providers associated with the de-identified healthcare information.

30. The method of claim 29 further comprising:
tagging the de-identified healthcare information with computer tags that identify the healthcare provider associated with each event reported in the de-identified healthcare information;
for each healthcare provider, designating in a computer no desired groups, or one desired group, or more than one desired groups, who may receive de-identified healthcare information associated with a particular healthcare provider; and
receiving a request from a specific purchaser in a specific group and identifying the specific group of the specific purchaser; and
based on the specific group of the specific purchaser, the computer tags and the desired groups designated for each health care provider, providing to the specific purchaser only the de-identified healthcare information designated for the specific group of the specific purchaser.

31. The method of claim 29 further comprising:
tagging the health care provider profile information using profile tags for each health care provider to identify the types of purchasers allowed to access the healthcare provider profile information; and
for each purchaser, allowing access only to selected healthcare provider profile information based on the profile tags.

32. A method for aggregating and distributing healthcare information, wherein healthcare information is stored in a plurality of first computer databases implemented on computers, each first computer database including hardware, software and electronic data, each item of healthcare information being associated with a patient and at least one healthcare provider, the healthcare information including identifying information that identifies the associated patients and the associated healthcare providers; the method comprising:
establishing communication between the first computer databases and a broker computer database implemented on a computer, the broker computer database including hardware, software and electronic data;
establishing communication between the broker computer database and a purchaser;
generating de-identified healthcare information that is aggregated from the healthcare information in the plurality of first computer databases and includes some of the healthcare information but does not include specific identifying information that could specifically identify a particular healthcare provider; said de-identified healthcare information including demographic information characterizing each healthcare provider, the demographic information being insufficient to uniquely identify a specific health care provider;
storing at least a portion of the de-identified healthcare information in the broker computer database;
providing information corresponding to the de-identified healthcare information to purchasers;
charging fees to purchasers who receive information corresponding to the de-identified healthcare information; and
compensating one or more of the healthcare providers associated with the de-identified healthcare information.

33. The method of claim 32 wherein said de-identified healthcare information includes demographic information characterizing each healthcare provider, the demographic information being insufficient to uniquely identify a specific health care provider; and further comprising analyzing the de-identified healthcare information based on the demographic information to determine types of healthcare providers represented in the de-identified data and to organize the data by types of healthcare providers to produce analyzed data;
providing purchasers with information corresponding to the analyzed data;
charging a fee to purchasers who receive information corresponding to the analyzed data; and
compensating one or more of the healthcare providers associated with the de-identified healthcare information based in part on the analyzed data provided to the purchasers.

34. The method of claim 32 wherein the step of generating de-identified healthcare information further comprises deleting information that would identify specific healthcare providers and for each healthcare provider inserting provider demographics related to the provider or his practice.

35. The method of claim 34 wherein the provider demographics comprise one or more of an age range of the healthcare provider, a geographic area in which the healthcare provider is located, the specialty of the healthcare provider, and characteristics of a practice group, if any, of the healthcare provider.
